(19) United States
(12) Patent Application Publication
(10) Pub. No.: US 2026/0119698 A1
(43) Pub. Date: Apr. 30, 2026

(54) TOUCH-AWARE AUTHORIZATION THROUGH SEMANTIC QUERY INTROSPECTION IN HYBRID RELATIONAL DOCUMENT DATA SYSTEMS

(71) Applicant: Oracle International Corporation, Redwood Shores, CA (US)

(72) Inventor: Raman Grover, Palo Alto, CA (US)

(73) Assignee: Oracle International Corporation, Redwood Shores, CA (US)

(21) Appl. No.: 19/368,060

(22) Filed: Oct. 24, 2025

Related U.S. Application Data
(60) Provisional application No. 63/711,943, filed on Oct. 25, 2024.

(51) Int. Cl. G06F 21/62; G06F 16/2453

(52) U.S. Cl. CPC G06F 21/6227; G06F 16/24534

(57) ABSTRACT

Techniques are disclosed for touch-aware authorization and access control in hybrid data systems, including data systems supporting hybrid relational-document data models. In one aspect, a method includes receiving a query and determining a data path based on the query. The data path can include a set of touched paths of data in a data system. A touched path of the set of touched paths can be used to access a different touched path of the set of touched paths. Each touched path can be evaluated based on one or more access control policies to determine whether at least one touched path violates one or more access control policies. If at least one touched path violates one or more access control policies, access control of the data can be enforced by controlling the execution of the query on the data system.

### CROSS-REFERENCE TO RELATED APPLICATION

The present application is a non-provisional application of and claims the benefit and priority under 55 U.S.C. 119 (e) of U.S. Application 63/711,943, filed on Oct. 25, 2024, the disclosure of which is incorporated herein by reference in its entirety for all purposes.

### FIELD

The present disclosure relates generally to data systems, and more particularly, to techniques for improved data processing and access control in hybrid data storage systems.

### BACKGROUND

Heterogeneous and disparate data stores can make computing and querying data more flexible and efficient. Applications that interface with data storage systems can better query data that suit their needs, rather than being limited to a particular type of data query or store. The data storage system can also scale better to better optimize for different workloads.

In recent years, there has been a significant rise in capabilities of data storage systems. In particular, improvements in natural language processing (NLP) have increased the abilities of data storage systems to store semantic concepts of data stored with the storage system. Managing and processing data across various components, particularly for data storage systems with disparate data stores, data models, or the like can be difficult to maintain.

The improvement of data storage systems represents a significant advancement in making data storage systems more accessible and accurate. By improving capabilities of data storage systems, these systems can improve access to information across applications. This disclosure presents techniques related to improved data processing techniques in distributed data storage systems.

### BRIEF SUMMARY

Data processing techniques are disclosed herein (e.g., computer-implemented methods, systems, non-transitory computer-readable media storing code or instructions executable by one or more processors) for touch-aware authorization through semantic analysis of queries enabling improved data processing and access control for hybrid data systems.

In some embodiments, a computer-implemented includes receiving a query; determining a data path based on the query, wherein the data path comprises a set of touched paths of domain data in a data system, wherein one or more of the touched paths of the set of touched paths is used to access a different touched path of the set of touched paths; evaluating each touched path of the set of touched paths based on one or more access control policies, wherein the evaluating comprises determining whether at least one touched path of the set of touched paths violates the one or more access control policies; and in response to determining the data path includes the at least one touched path that violates the one or more access control policies, enforcing access control of the domain data by controlling execution of the query on the data system based on the one or more access control policies.

In some embodiments, the computer-implemented method further includes in response to determining the data path does not include the at least one touched path that violates the one or more access control policies, generating a query result based on the domain data.

In some embodiments, a predicted output of the query does not violate the one or more access control policies; and the data path includes the at least one touched path that violates the one or more access control policies.

In some embodiments, the data in the data system is hybrid data comprising relational data and document-based data.

In some embodiments, enforcing access control comprises at least one of (i) rejecting the query, (ii) rewriting an unauthorized expression of the query, (iii) masking a restricted field of the query, or (iv) a combination thereof.

In some embodiments, the query comprises a user-defined function (UDF), and wherein the computer-implemented method further includes: identifying, from a UDF registry, UDF metadata associated with the UDF, wherein the UDF metadata comprises at least one of (i) input parameters associated with the UDF, (ii) one or more touched paths associated with the UDF, and (iii) one or more data safety parameters; and determining, based on the UDF metadata, whether the UDF violates the one or more access control policies.

In some embodiments, the computer-implemented method further includes generating a query execution plan based on the data path, wherein the query execution plan comprises metadata for each touched path of the set of touched paths; and in response to determining the data path does not include the at least one touched path that violates the one or more access control policies, executing the query execution plan.

In some embodiments, determining the data path includes: generating a hierarchical data structure based on the query and the domain data in the data system, wherein at least part of the domain data corresponds to a nested structure; and performing a traversal of the hierarchical data structure to identify the set of touched paths.

Some embodiments include a system that includes one or more processors; and one or more computer-readable media storing instructions which, when executed by the one or more processors, cause the system to perform part or all of the operations and/or methods disclosed herein.

Some embodiments include one or more non-transitory computer-readable media storing instructions which, when executed by one or more processors, cause a system to perform part or all of the operations and/or methods disclosed herein.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

FIG. 1 is an example of an architecture for a computing environment for a clinical digital assistant in accordance with various embodiments.

FIG. 2 is a block diagram of a digital assistant runtime flow with components and

interfaces into a semantic index, in accordance with various embodiments.

FIG. 3 is a simplified block diagram of a computing environment of a disparate data storage system, in accordance with various embodiments.

FIG. 4 is a block diagram illustrating an exemplary computing environment implementing touch-aware authorization, in accordance with various embodiments.

FIG. 5 is a block diagram illustrating an exemplary flow for enforcing access control with touched paths in a hybrid data system, in accordance with various embodiments.

FIG. 6 is a flowchart of a process for processing queries using touch-aware authorization, in accordance with various embodiments.

FIG. 7 is a block diagram illustrating one pattern for implementing a cloud infrastructure as a service system, in accordance with various embodiments.

FIG. 8 is a block diagram illustrating another pattern for implementing a cloud infrastructure as a service system, in accordance with various embodiments.

FIG. 9 is a block diagram illustrating another pattern for implementing a cloud infrastructure as a service system, in accordance with various embodiments.

FIG. 10 is a block diagram illustrating another pattern for implementing a cloud infrastructure as a service system, in accordance with various embodiments.

FIG. 11 is a block diagram illustrating an example computer system, in accordance with various embodiments.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

### INTRODUCTION

In recent years, the amount of data powering various industries and their systems has been increasing exponentially. Organizations and businesses store and consume data across various types of data stores (e.g., relational databases, non-relational databases, object stores, key-value stores, file storage, etc.). These data stores power information systems across multiple industries, for instance, consumer tech (e.g., orders, cancellations, refunds), supply chain (e.g., raw materials, stocks, vendors), healthcare (e.g., medical records), finance (e.g., financial business metrics), customer support, search engines, and much more. Data that powers these industries can come from a variety of different sources and it is imperative for modern data-driven organizations to maintain consistent and reliable data to provide accurate representations of data to users.

With the rise of natural language (NL) processing and artificial intelligence capabilities, storing and providing data in ways that maintain semantic coherence and meaning can improve user queries and interactions with data storage systems. It is vastly more efficient for non-technical users (e.g., business leaders, doctors, or other users of the data) directly interact with analytics tables via natural language (NL) queries that abstract away underlying query language and/or data structures of a data storage system. Further, for data storage systems with multiple sources of data reflected within the storage systems, querying the system with a single unified structure can make accessing data more efficient and reduce user burden. By providing unified query and storage structures, even technical users with strong understandings of one type of data storage but lacking knowledge in other types of data storage can better query a data storage system based on types of data storage and querying implementations they are comfortable with.

Implementing a Semantic Object Model in a data environment with disparate and/or distributed data stores can be a powerful tool for unifying data across disparate and/or distributed data stores while providing efficient access to data. Unlike other data models, which often only define objects by structure, a Semantic Object Model can define objects by their semantic meaning and relationships. Objects are represented as concepts associated with various attributes and relationships that can be leveraged to determine semantics and meaning. For example, in a healthcare environment, a patient can be represented as a concept, and semantic objects (SOs) corresponding to a patient concept can include various attributes that can describe the patient such as name, address, phone number, and the like. In some implementations, semantic objects can include self-describing metadata and/or linked actions for custom operations.

In many data environments, data stores included in heterogeneous systems can support hybrid data models. In particular, some databases can implement hybrid relational-document data models that combine structured and semi-structured data. Such hybrid storage models can include relational tables combined with document fields (e.g., JSON, XML, protocol buffers, etc.). Implementing databases that support hybrid data including relational and document-based data can improve flexibility and expressiveness of querying data by enabling structured queries of relational models with the flexibility of document-based formats in instances of schema changes. In certain domains, such as healthcare and financial domains, hybrid data models can be especially useful due to the flexibility in storing semi-structured data (e.g., doctor's notes, diagnostic results) and interacting with semi-structured external sources (e.g., market feeds, Fast Healthcare Interoperability Resources (FHIR) data) while maintaining transactional integrity by enabling querying of relational fields.

However, implementing hybrid data models can also increase privacy concerns particularly when analyzing queries that access nested fields within semi-structured data. Nested fields can contain sensitive and critical information such as medical conditions, financial attributes, or behavioral metadata that may be governed by regulatory requirements (e.g., HIPAA, GDPR) that enforce rules over which users can access such data. Accordingly, understanding the touched paths of a query when processing a request for data in an environment with sensitive information can be important to safeguard the sensitive information and ensure damaging information leaks do not occur because of access policy violations. In particular, evaluating authorization policies, which can include rules that define whether a user or other entity has permission to access certain resources (e.g., data) or perform certain actions, with consideration of nested structures can be important for such sensitive data in hybrid data systems. Similarly, enforcing access control policies that define whether to grant or block access to resources and/or services based on the permissions (e.g., as defined by authorization policies) of a user or other entity.

A touched path can refer to any field (e.g., flat and/or nested) whose value is read from storage or memory to evaluate a given query. This can include direct column references, hierarchical document paths, intermediate fields in computed expressions, fields passed to or accessed within functions, and any field required during query planning or execution, even if it does not appear in the final output. Determining touched paths when enforcing access control can be important to ensure that no field restricted by access control policies is accessed by a query, particularly in data systems with hybrid data models containing nested structures that can complicate the types of touched paths in a query. As used herein, the set of touched paths referenced within a query can be referred to as a data path. Within a data path, one or more touched paths can be used to directly or indirectly access another touched path within the data path. For example, the data path can include a subfield within a JSON object. To access the subfield, a field path (e.g., using dot notation, bracket notation) or hierarchical traversal of fields within the JSON object is performed. As another example, a touched path can be a condition within a query (e.g., a filter condition, join condition, etc.) that is used to access values associated with another touched path (e.g., a direct column reference in a select statement).

Conventional techniques for access control, however, are often limited in their abilities to accurately handle all touched paths in a query, particularly in analyzing access control policies. Traditional systems for authorization and access control implemented typically offer row-level security and attribute-based access control. In such authorization mechanisms, access control is enforced at parse time and/or by view layer rewriting and can fail to account for all touched paths that are evaluated internally during query execution. In particular, such authorization mechanisms typically enforce output-only authorization by restricting access based on the projected result of the query. By limiting authorization to access control enforcement of an output, however, such techniques fail to properly account for other fields and/or clauses within the query that can influence a query result. For example, while an access control policy may restrict access to data in certain columns, output-only authorization performed on a SQL query may only apply the access control policy to columns within a SELECT clause of a SQL query. Fields used in WHERE filters, JOIN conditions, aggregate functions, etc. are often overlooked by such output-only authorization, which can enable a user to perform unwanted operations such as filtering results based on restricted and sensitive data (e.g., using a sensitive field in a WHERE clause to filter a column that is not sensitive). As a result, such authorization techniques are particularly susceptible to inference attacks that can evade access control by using query structure, output shape, and query metadata to influence query results, even in data systems that do not include hybrid data models and/or nested structures.

Furthermore, conventional authorization techniques are limited by their ability to evaluate access control for semi-structured data. Hybrid data models embed semi-structured data typically expose fields through accessors. However, such accessors and document-related structures can be difficult for access control systems to evaluate. These fields are commonly treated opaquely as black boxes to the access control system. Traditional access control systems also often do not perform any introspection into the nested fields within the semi-structured data and are unable to account for dereferenced paths with semi-structured formats supported by hybrid data models. Due to such limitations, access control policies may not be enforced at the granularity of sub-fields within the semi-structured data, which can allow queries to bypass access policies through hidden access paths using nested fields.

Similarly, conventional techniques often do not properly account for complex constructs in joins, subqueries, computed columns and user-defined functions (UDFs). A UDF is a function written by a user to perform specific operations and tasks on data within the database in a repeatable manner. UDFs can accept parameters and can be called in queries to return certain values (e.g., table, scalar, etc.). UDF logic may be unknown to access control implementations and some authorization systems ignore UDF logic by assuming UDFs are safe, which can consequently pose significant risks when executing queries that call UDFs. Some authorization systems block all queries using UDFs to avoid security risks, but this can lead to reduced usability for users querying a database.

Conventional techniques for analyzing, optimizing, and planning queries (e.g., using tools like an EXPLAIN command) typically show the cost and operators involved in a query but do not surface the set of touched fields per operator for analysis by a user or other entity. Consequently, users and other entities, particularly security administrators, lack visibility to the data that was accessed during execution, which can prevent accurate auditing, traceability, and authorization enforcement. Such techniques for query planning and analysis are also performed within a database without any knowledge or context of access policies and authorization rules of a particular system. As a result, evaluating access control with awareness of touched paths using traditional query analysis and optimization can be infeasible. This is especially applicable in data systems with disparate and federated data stores, where each data store may have various structures for touched paths. For example, due to differences in data models, a touched path in a vector database may not be the same as a touched path in a relational database when querying the same data. Furthermore, enforcing access control within each data store of a data system is often not possible due to the complexity of access control and authorization policies and due to the policies being defined by an application that stores them outside of a data store (e.g., in a policy engine). As such, applying access control across data stores within the data system can be especially challenging without a unified method of performing authorization and access control analysis.

To overcome these challenges and others, techniques are disclosed herein for improving enforcement of authorization and access control in a data system by leveraging analysis of touched paths in a query. A query received at a data system is processed to determine a data path including a set of touched paths associated with the query. In examples where the data is stored in a nested structure (e.g., hybrid data including relational data and document-based data), a touched path in the set of touched paths may be used to access a different touched path in the sequence (e.g., a filter condition, join condition, etc.). Each touched path is evaluated to determine whether at least one touched path violates one or more access control policies. If one or more touched paths violate one or more access control policies, an enforcement mechanism can be applied to the query. Optionally, a UDF registry can be maintained to determine if a UDF includes touched paths that violate one or more access control policies. As examples of applying an enforcement mechanism, the query can be rejected, rewritten, and/or all or a portion thereof masked.

In one exemplary embodiment, a computer-implemented method is provided that includes receiving a query; determining a data path based on the query, wherein the data path comprises a set of touched paths of domain data in a data system, wherein one or more touched path of the set of touched paths is used to access a different touched path of the set of touched paths; evaluating each touched path of the set of touched paths based on one or more access control policies, wherein the evaluating comprises determining whether one or more touched paths of the set of touched paths violates the one or more access control policies; and in response to determining the data path includes the at least one touched path that violates the one or more access control policies, enforcing access control of the domain data by controlling execution of the query on the data system based on the one or more access control policies.

By enabling touch-aware authorization, the techniques are disclosed herein to implement touch-aware authorization using analysis of touched paths in queries to identify access control violations. Touch-aware authorization directly addresses challenges with implementing access control using conventional authorization mechanisms. By evaluating the touched paths of a query and determining access control violations for each touched path, the techniques herein address issues in information leakage due to access policy evaluations on fields explicitly returned an output of a query. The use of touched path analysis can also enable authorization enforcement proactively before execution of the query, rather than reactive enforcement on the result set as typically implemented. This can prevent information leakage through query formulations that allow partial inferences of sensitive information (e.g., filters on sensitive fields without projection). Furthermore, the techniques described herein provide improvement in handling hybrid relational-document models by enabling touched path analysis of nested fields in semi-structured data. The use of a UDF registry directly address challenges in handling access control of UDFs by enabling more comprehensive access policy violations of UDFs. Additionally, touch-aware authorization can improve access control in heterogeneous data environments with federated data stores by implementing a common abstraction of authorization that can be applied to queries for any data store within the environment. For example, in some implementations, authorization functionality is performed in a dedicated middleware layer, which directly addresses challenges in implementing authorization within individual data stores in a data system.

As used herein, when an action is “based on” something, this means the action is based at least in part on at least a part of the something.

As used herein, the terms “similarly”, “substantially,” “approximately” and “about” are defined as being largely but not necessarily wholly what is specified (and include wholly what is specified) as understood by one of ordinary skill in the art. In any disclosed embodiment, the term “similarly”, “substantially,” “approximately,” or “about” may be substituted with “within [a percentage] of” what is specified, where the percentage includes 0.1, 1, 5, and 10 percent.

### Overview of Clinical Digital Assistant Architecture

Various types of entities (in this context an entity refers to a person, computing device or system, or software, e.g., users, applications, services such as SaaS, digital assistant systems, database subsystems, etc.) may access a data storage system as described above. In many instances, a heterogeneous data system with disparate data stores that provide different combinations of functionality and data access can be useful to improve application and service workflows and to provide end users with a better experience. A particular example of an environment that can interact with a data storage system to improve functionality and end user experience is in health care environments for accessing clinical data.

Providing healthcare to patients typically requires a healthcare provider (e.g., a physician, nurse professionals, other healthcare professionals, etc.) to repeat a number of common tasks for each patient. For example, regardless of the specific reason for an interaction between a healthcare provider and a patient, or the condition of a given patient, the healthcare provider must typically document the patient interaction. For example, the healthcare provider may record the patient interaction in a subjective, objective, assessment, and plan (SOAP) note, or may enter information gained during the patient interaction into a patient record. The healthcare provider may also engage in various other tasks directly or indirectly related to administering healthcare to the patient, such as requesting additional patient information in the form of charts or images, calling in patient prescriptions, and calendaring future tasks, events, and associated reminders.

Performing such healthcare tasks according to known and commonly used methods can be time consuming. In fact, given the typically high volumes of patient encounters, healthcare providers often spend a considerable portion of their workday documenting patient interactions and associated medical information, which reduces the amount of time available to the healthcare provider to administer actual patient care or perform other more critical tasks. For example, healthcare providers may spend considerable time on a daily basis typing or manually entering patient information into electronic health record (EHR) systems. In addition to being time consuming, this process can be, tedious, and prone to errors such as but not limited to typographical errors, which can result in inaccuracies and inconsistencies in patient records, and can potentially compromise patient safety and the quality of care provided. Traditional EHR systems can also have complex interfaces any may be difficult to navigate, which can increase the time required for healthcare providers to complete such repetitive tasks and generally frustrate the process Traditional EHR system devices may also be cumbersome to operate, and a lack of intercommunication between such devices prevents a healthcare provider from switching between devices while in the process of performing a task even if doing so would be more efficient. These issues may negatively affect patients as well as healthcare providers. For example, patient information may often be retrieved for review or discussion during a patient interaction or recorded during a patient interaction to ensure accuracy. When the process for retrieving or recording such information is inefficient, as is often the case when performed using traditional systems and methods, it can disrupt the natural flow of the patient interaction and may result in a less seamless and less fulfilling experience for the patient. The tedium and time requirements associated with repetitively performing these tasks can also contribute to healthcare provider burnout. Furthermore, such tasks require consistent and accurate access to data, and steps taken to ameliorate and improve task performance (e.g., through automation or otherwise) must also guarantee accurate and consistent access to clinical and/or patient data.

A digital assistant can be implemented using a clinical digital assistant (CDA) framework as described below to improve workflows and capabilities for healthcare providers.

The CDA framework interacts with end users and backend systems to enhance healthcare workflows by integrating APIs, multi-modal user interface (UI), and Electronic Health Record (EHR) data sources. End users (e.g., healthcare providers) may interact with the CDA through natural language based conversational experiences. The CDA framework includes generative model (e.g., LLM) based agents that can perform specific functionality (e.g., as defined by a plugin, service level logic, etc.) to provide specialized AI capabilities. In response to a user input, an agent can perform one or more actions including, but not limited, to UI actions that enable conversational interaction against a UI element (e.g., filtering content, adjusting visualization), API actions, and data actions (e.g., retrieving relevant data from a data system). To provide access to internal and external knowledge sources including longitudinal records of a patient and domain-specific knowledge, the CDA framework can include a healthcare semantic index. The healthcare semantic index is a heterogeneous data storage system described above that stores and indexes data, such as patient data, and can enable generative model-based agents to reason across knowledge and data sources through natural language metadata (e.g., as stored in semantic objects) and clinical embeddings (e.g., numeric representations) of unstructured text, images, and discrete data. Access to such data can be important in healthcare settings. For example, a physician performing a chart review may need knowledge about relevant drugs for a condition, interactions between drugs, and interactions between drugs and foods in addition to patient-specific data, such as treatment history.

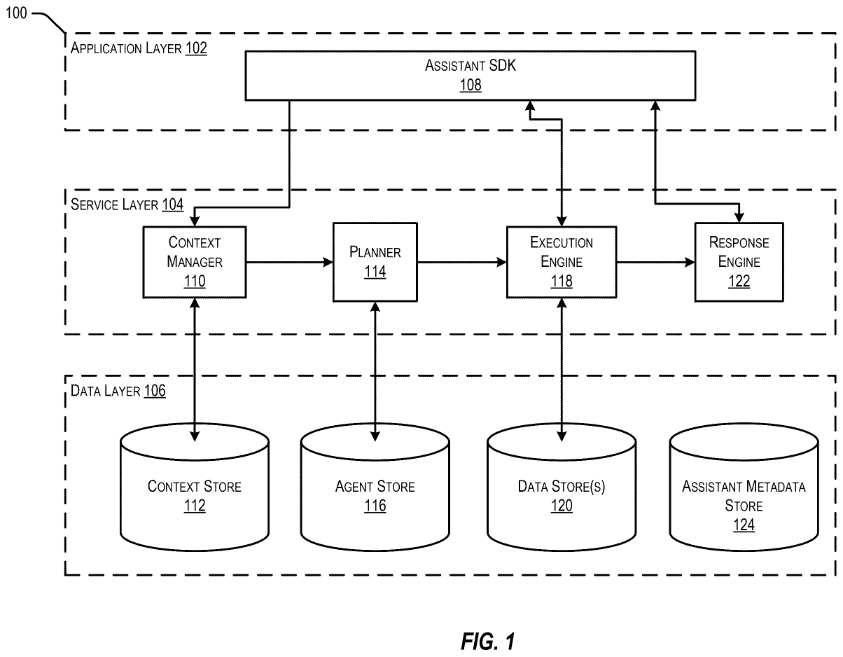

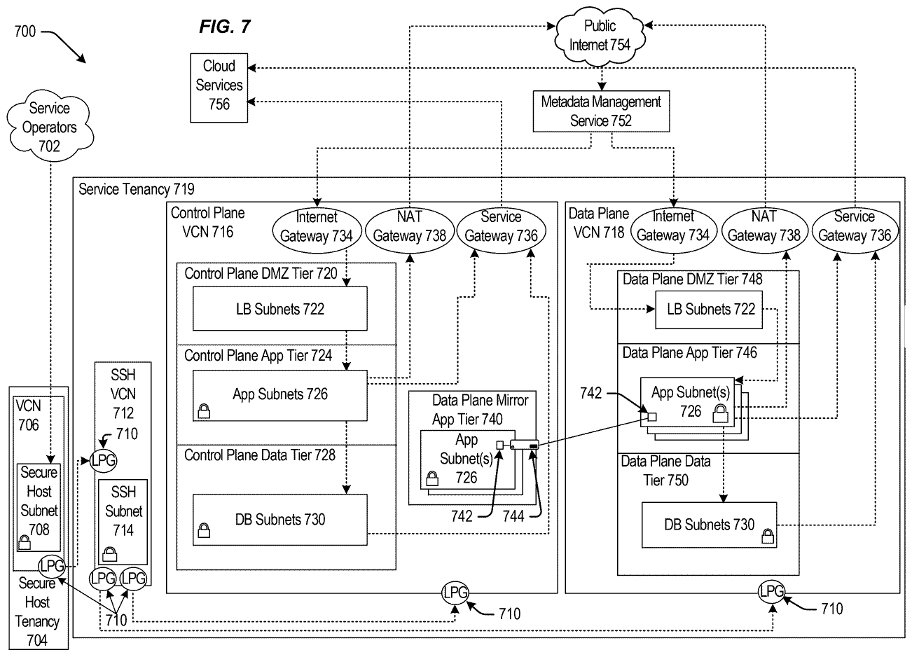

FIG. 1 is an example of an architecture for a computing environment 100 for a clinical digital assistant in accordance with various embodiments. The computing environment 100 can include additional components, fewer components, or different components. In some instances, the computing environment 100 is part of an Infrastructure as a Service (IaaS) cloud service (described in more detail with respect to FIGS. 7-11) and the clinical digital assistant can be implemented as part of the IaaS by leveraging the scalable computing resources and storage capabilities provided by the IaaS provider to process and manage large volumes of data and complex computations.

The computing environment can include various layers including an application layer 102, service layer 104, and data layer 106. Each layer may include components that interact to provide a healthcare workflow as described above. The data layer 106 can be or can include a healthcare semantic index. The application layer 102 can include an assistant software development kit (SDK) 108 that can process user inputs provided by a user through an interface (e.g., a user interface, voice interface, etc.) of an application shell. Examples of user inputs include, but are not limited to, user speech commands, user text commands, user clicks, etc. Additionally or alternatively, the assistant SDK 108 can receive inputs via backend events generated in response to user interactions (e.g., user click events, backend changes, etc.). The assistant SDK 108 can be configured to interact with various components of the service layer 104 (e.g., providing user inputs to the service layer 104, receiving responses from the service layer 104, etc.).

The application layer 102 provides user inputs to a context manager 110 of the service layer 104. The context manager 110 prepares contextual information that can be utilized by components of the service layer 104 to generate a relevant response to the user input and/or user action. The context manager 110 retrieves one or more contexts from a context store 112. A context can act as a holder object for metadata associated with contextual information related to a conversation history, session history, previous executions, etc. The context store 112 can store contexts including, but not limited to, user context, application context, session context, etc.

Additionally or alternatively, the context manager 110 may retrieve metadata from an assistant metadata store 124. The assistant metadata store 124 may store metadata for semantic objects and/or plugins that define one or more agents and can be used to identify and select agents and/or actions based on the user input.

The context manager 110 provides contextual information to a planner 114. The planner 114 can be or can utilize one or more generative models (e.g., LLMs or LMMs) fine-tuned to create an execution plan with specified parameters either from a user input (e.g., an utterance), the action performed by the user, the context, or any combination thereof. The execution plan identifies one or more agents and/or one or more actions for the one or more agents to execute in response to the and/or action performed by the user.

The planner 114 can include a retrieval component that retrieves candidate agents and/or actions from the agent store 116. The retrieval component may execute a query on indices of an agent store 116 based on the user input and/or action performed by the user. In some instances, the retrieval component performs a semantic search using words from the user input and/or representative of the action performed by the user. The semantic search uses NLP and optionally machine learning techniques to understand the meaning of the user input and/or action performed by the user and retrieve relevant information from the data layer 106. In contrast to traditional keyword-based searches, which rely on exact matches between the words in the query and the data in the data layer 106, a semantic search takes into account the relationships between words, the context of the query and/or action, synonyms, and other linguistic nuances. This allows the clinical digital assistant to provide more accurate and contextually relevant results, making it more effective in understanding the user's intent in the utterance and/or action performed by the user. The planner 114 can use the candidate agents and/or candidate actions retrieved from the agent store 116 and context determined by the context manager 110 to generate an execution plan listing and/or describing actions that can be executed based on the user input. For example, the planner 114 can determine parameters for the selected action(s) and include the parameters in the execution plan.

The execution plan is transmitted to an execution engine 118 configured to execute the actions of the execution plan. For example, for API actions, the execution engine 118 may execute one or more API calls. For UI actions, the execution engine 118 may populate properties needed to execute the action. For data actions such as knowledge retrieval, the execution engine 118 can execute a query against the data layer 106 (e.g., on one or more data store(s) 120) to retrieve data relevant to the user input. In some examples, to execute a data action, the execution plan can include a semantic search as described that can be executed by the execution engine 118 on the data store(s) to identify relevant information or data (e.g., clinical data related to a certain concept, etc.).

The data layer 106 can be a heterogeneous and disparate data environment as described above. The data layer 106 can include one or more data store(s) 120 that can store patient data (e.g., patient notes, patient discrete data, etc.) and patient agnostic data (e.g., drug information, disease information, drug interaction databases, etc.). The data store(s) 120 can store structured and unstructured data based on the combination of data store(s). For example, the data store(s) 120 may store clinical embeddings (e.g., in a vector database) to embed knowledge that can be accessed by the service layer 104 and raw data can be enriched by linking information to code-sets (e.g., SNOMED, ICD-10, etc.). Clinical concepts can be stored as semantic objects within the data store(s) 120. The data layer 106 can include data that is kept consistent with a source EHR system. For example, patient data stored in the data layer 106 may be kept consistent with a one or more databases of traditional EHR system through a data ingestion process. As such, changes to patient data made on an external system (e.g., a traditional application used by healthcare providers) can be propagated to the data layer 106 to ensure patient data is accurate irrespective of where the changes are made.

Execution output(s) generated by the execution engine 118 (e.g., data retrieved from the data store(s) 120, API responses, etc.) is transmitted to a response engine 122. The response engine 122 can be or can utilize one or more generative models (e.g., LLMs or LMMs) to generate a response to a user. The response can be a multi-modal response that combines response from different executions into a final response. For example, the response can be text, images, tables, UI elements, action executable by the assistant SDK 108, etc. Response(s) generated by the response engine 122 are transmitted to the assistant SDK 108. The assistant SDK 108 can transmit the response(s) to an application shell to provide the response to the user (e.g., via a user interface, voice interface, etc.).

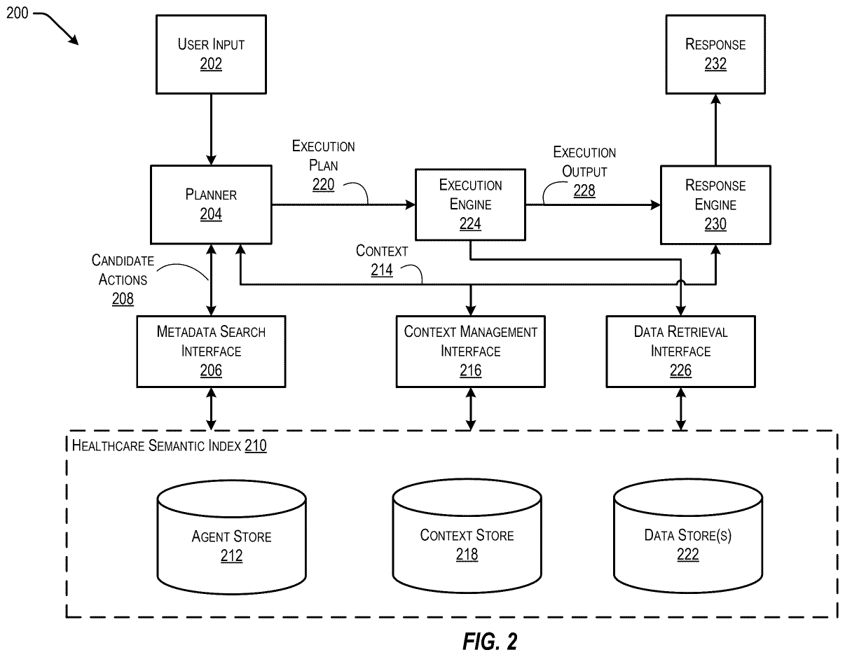

FIG. 2 is a block diagram of a digital assistant runtime flow 200 with components and interfaces into a semantic index, in accordance with various embodiments. As illustrated in FIG. 2, A user input 202 can be provided to a planner 204 (e.g., planner 114 of FIG. 1). The user input 202 can be a natural language utterance, user interface action, programming language query, or other forms of user inputs. In this walkthrough, it is assumed that the user is a healthcare provider interested in knowing medical data of a patient. The healthcare provider provides the following input: Has the patient's total cholesterol level ever been over 180?

Based in the user input 202, the planner 204 accesses a metadata search interface 206 to retrieve appropriate candidate actions 208 from the healthcare semantic index 210 (e.g., data layer 106 of FIG. 1). The candidate actions 208 may be retrieved from an agent store 212 that stores a set of actions associated with one or more agents. Candidate actions 208 can be potential actions determined to meet a confidence threshold for a potential topic related to the user input 202. In some examples, candidate actions 208 can be determined by executing a semantic search on the agent store 212 and identifying actions that satisfy a similarity threshold. Examples of candidate actions 208 include, but are not limited to, UI actions, API actions, data actions, etc. For the above input provided by the healthcare provider, the candidate actions can include actions such as getObservations, getVitals, displayChart, etc. which may each be predefined actions associated with UI changes, data retrieval, API execution, etc.

The planner 204 retrieves context 214 containing contextual information related to the conversation history via a context management interface 216. The context 214 is retrieved from a context store 218 and can include contextual information based on a conversation history and/or session history between the healthcare provider and digital assistant. For example, the context 214 can include a patient id, a current time, previous user utterances, previous responses, etc. For the example of the user input provided by a healthcare provider above, the context 214 can identify the patient referenced in the healthcare provider's input as having a patient identifier value of ‘123’ based on information associated with the session and/or previous interactions (e.g., utterances) between the healthcare provider and the digital assistant.

Based on the retrieved candidate actions 208 and context 214, the planner 204 generates an execution plan 220 that can be executed to answer the healthcare provider's question. The planner 204 selects the most appropriate candidate action of the retrieved candidate actions 208. For the above example, the planner 204 may select the getObservations action to retrieve the patient observations from the healthcare semantic index 210. Additionally, the planner 204 may determine parameters needed to execute the selected action. The parameters can include, for example, an API payload or a query that can be executed on one or more data store(s) 222 of the healthcare semantic index 210. As described with respect to FIG. 1, the planner 204 can be or can make use of one or more LLMs to generate the execution plan 220. In some examples, the candidate actions 208 and context 214 may be provided as a prompt to the planner 204 and/or one or more generative models used by the planner 204 to generate the execution plan 220. For the above example user input 202, the parameters can include a query that can be executed on the healthcare semantic index 210 to retrieve the patient's cholesterol level. A generated execution plan 220 can be as follows:

| | |
|---|---|
| - | Action: getObservations |
| - | Parameters: |
| | query: SELECT * FROM Observations WHERE vitalSigns = ‘Total |
| | Cholesterol’ AND patientID = ‘123’ and value > 180 |

The planner 204 provides the execution plan 220 to an execution engine 224 (e.g., execution engine 118 of FIG. 1). The execution engine 224 executes the execution plan 220 to generate an execution output 228. For data actions, the execution engine 224 can execute the execution plan 220 via a data retrieval interface 226. The data retrieval interface 226 can be a programmatic interface for query execution on the healthcare semantic index 210. In some implementations, the data retrieval interface 226 can be or can include one or more API endpoints. Data for a query in the execution plan 220 can be retrieved from one or more data store(s) 222 of the healthcare semantic index 210. The data store(s) 222 can include clinical data stores and may include data stores of various types, including but not limited to relational databases, vector databases, etc.

An execution output 228 generated by the execution engine 224 based on the execution of the execution plan 220 is provided to a response engine 230. The execution output 228 can include data retrieved by execution the execution plan 220, an output of an API call, an action to be performed by an application (e.g., a UI action), references to sources of data and/or outputs, or combinations thereof. The response engine 230 can generate a rich output with appropriate data elements in the output. The response engine can be or can make use of one or more generative models to generate the response 232 that is provided to the user. The response can be an event that is provided to a user, multi-modal response, references, a query result, etc., generated based on the execution output 228 of the execution engine 224. Additionally or alternatively, the response engine 230 can retrieve context 214 (e.g., as retrieved and used by the planner 204) to generate the response 232 with contextual information. For example, the response engine 230 may determine that the name of the patient with patient id ‘123’ as identified above is “Grace” and may include the patient's name in the response 232. A response to the healthcare provider with the above question can be a text and tabular response as follows:

Grace's total cholesterol level was reported
to be over 180 mg/dL in the last 2 Lipid Panels.

| Type | Date | Results |
|---|---|---|
| Lipid Panel | Feb. 17, 2024 | Total: 220 mg/dL (elevated) |
| | | HDL: 60 mg/dL (normal) |
| | | LDL: 150 mg/dL (elevated) |
| Lipid Panel | Nov. 17, 2023 | Total: 230 mg/dL (elevated) |
| | | HDL: 60 mg/dL (normal) |
| | | LDL: 160 mg/dL (elevated) |

### Overview of Semantic Index

A Semantic Object Model (SOM) can be an effective way of abstracting data to provide a unified view of data that transcends limitations of individual data storage methods, models, schemas, etc. within a data storage system. A semantic object stored within a data system can represent a particular concept and include various attributes associated with the particular semantic object. In some implementations, the semantic object can include self-describing metadata and/or linked actions for custom operations. The semantic object metadata can be used by a model (e.g., a generative model such as an LLM, etc.) to query the model.

Semantic Index (SI) is a data storage system implementing a Semantic Object Model including disparate and varying types of data stores. SI can store data in a custom way spanning multiple storage systems, abstracting from applications and providing a unified, durable, consistent and powerful data store. As a non-limiting example, SI can be used in healthcare environments (e.g., as described above with respect to the data layer 106 of FIG. 1 and healthcare semantic index of FIG. 2) to improve data accessibility for healthcare professionals and improving patient treatment. Semantic objects within SI can reflect clinical concepts (e.g., patients, treatments, observations, etc.). SI can maintain consistency with a primary source of truth (e.g., an electronic health record (EHR) system of record) to provide patient data related to medical history, diagnoses, etc. Many legacy applications used by healthcare providers rely on prominent platforms supporting conventional EHR systems of record for managing and interfacing with patient and clinical data. For new applications, it can be beneficial to introduce improved semantic techniques to improve access to patient and clinical data. However, for patient records to remain consistent across data platforms and applications, it is important the patient records remain consistent across data models and systems.

In some embodiments, a digital assistant, or chatbot, can interface with the Semantic Index to enable a user to query patient history and data more efficiently. For instance, a digital assistant may be able to query SI using semantic queries generated by a generative model (e.g., a Large Language Model (LLM), etc.). A user may interact with the digital assistant using natural language and then convert the reactions into intelligible queries, such as for clinical questions, etc.

In the interest of clarity of explanation, embodiments of the present disclosure are described in connection with particular data storage systems (e.g., Semantic Index), services (e.g., digital assistants), data models (e.g., Semantic Object Model, relational data models, etc.). However, the embodiments are not limited as such and instead, similarly, and equivalently apply to any data storage system, data models, and services in a multi-data store environment.

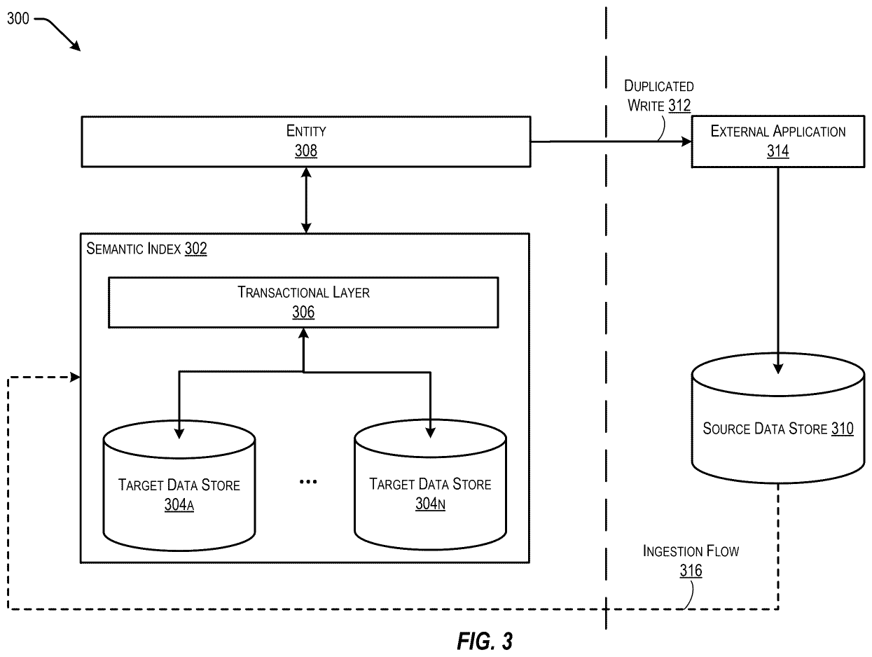

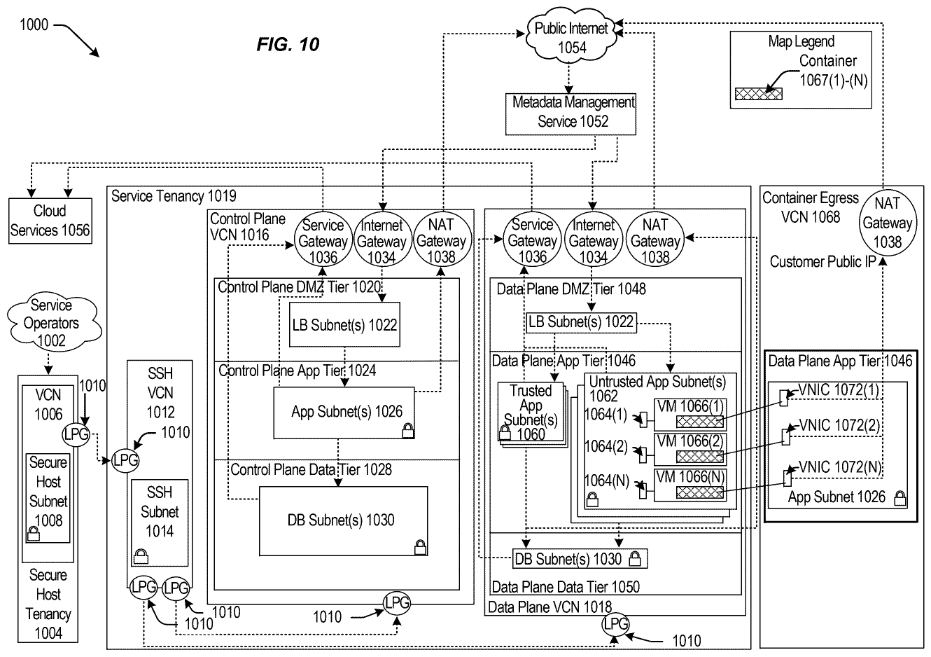

FIG. 3 is a simplified block diagram of an environment 300 of a distributed storage system incorporating Semantic Index. In some instances, the computing environment 300 is part of an Infrastructure as a Service (IaaS) cloud service (as described in more detail with respect to FIGS. 10-14) and semantic index can be implemented as part of the IaaS by leveraging the scalable computing resources and storage capabilities provided by the IaaS provider to process and manage large volumes of data and complex computations. Environment 300 includes Semantic Index (SI) 302 implementing protocols for semantic retrieval of data as described above. While the description of this figure may include various components and processed, it should be understood that additional components, fewer components, or different components as described can be implemented to provide the desired impact.

Semantic Index (SI) 302 can include multiple data stores (e.g., target data store 304a, target data store 304b). In some examples, one or more data stores of target data stores 304a-n are database(s) deployed in a cloud environment using an IaaS cloud service (e.g., as described in more detail with respect to FIGS. 10-14). Each data store within SI 302 may be a different type of data store. For example, target data store 304a can be a vector database (e.g., OpenSearch, Pinecone, etc.) and target data store 304b can be a relational database (e.g., Oracle, MySQL, PostgreSQL, etc.). Additionally or alternatively, Semantic Index 302 can include data stores including, but not limited to, a graph database, NoSQL database, key-value stores, message queues, object stores, etc. Target data stores 304a-n may each contain copies of the same data but provide multiple methods to query and access the data.

While target data stores 304a-n may each be the same and/or different type of data store, each target data store 304a-n may follow the same schema and/or data model. For example, SI 302 can implement the Semantic Object Model as described above, and each target data store 304a-n may implement a schema compatible with the Semantic Object Model. As a particular example, target data store 304b can be a relational database that implements semantic object concepts as tables within the target data store 304b (e.g., patient table, etc.). Attributes of semantic objects may be represented as columns in within each table. In some examples, relationships between semantic objects in a relational database may be represented as foreign keys reflecting references to other tables within the target data store 304b.

SI 302 includes a transactional data layer 306 (e.g., data retrieval interface 226 of FIG. 2) that can process queries to SI 302. The transactional layer 306 can support various types of queries, including, but not limited to QDSL, SQL, ingestion from external sources, etc. Additionally or alternatively, the transactional data layer 306 provides a software development kit (SDK) and/or application programming interface (API) that enables an entity 308 (e.g., a user, application, digital assistant, etc.) to interact with Semantic Index 302. For example, the transactional layer 306 includes an API allowing the entity 308 to read and/or write data to SI. The transactional layer 306 can act as an abstraction of the data stored in SI to the entity 308. For example, the entity 308 can call the API to request access to certain data without having knowledge about specific implementations of data models, schemas, and/or data stores within SI 302. Alternatively or additionally, the entity 308 can query SI using a SQL statement, a vector search, or the like. As such, the entity 308 can query and write to SI based on their own internal data models and/or schemas without understanding specifics about the data storage implementations in SI 302. As a particular example, the entity 308 can be a component of a digital assistant system (e.g., planner 204 of FIG. 2) with the capability to receive natural language utterances from a user and determine an execution plan including the execution of one or more programming language queries to retrieve data for addressing and/or responding to the utterances.

In the environment 300 depicted in FIG. 3, writes to SI 302 can occur as a direct write by the entity 308 and/or ingested writes propagated from a source data store 310. The source data store 310 may be a data store externally managed by another organization and/or located in a separate data environment. The source data store 310 may implement a different schema and/or data model than SI 302 and target data stores 304a-n. In some implementations, to maintain consistency between data stored in the target data stores 304a-n and the source data store 310, each direct to SI 302 by the entity 308 may be duplicated to the source data store 310 via a duplicated write 312 provided to an external application 314. The external application 314 may execute the duplicated write 312 on the source data store 310. As an example, in healthcare environments (e.g., as described above with respect to FIGS. 1-2), the source data store 310 can be a database associated with an EHR system. A direct write to SI 302 can include changes to patient data in SI 302. Such changes to patient data are duplicated to the EHR system by providing the duplicated write 312 to the external application 314 (e.g., an application traditionally accessed by a doctor to update patient data) to ensure patient data is consistent.

SI 302 can maintain consistency between the target data stores 304a-n and the source data store 310 via an ingestion flow 316. Data stored in the source data store 310 may be replicated and concurrently stored in the target data stores 304a-n. In some instances, target data stores 304a-n can include data not stored in the source data store 310. For example, SI 302 may store summaries for semantic objects (e.g., stored within a metadata store in SI) that are not compatible with the schema and/or data model implemented by the source data store 310.

Writes to SI can be writes propagated from SI. For example, the external application 314 may execute a direct write on the source database (e.g., a doctor may use PowerChart to update patient data). In eventually consistent models, writes to the source database should be propagated to the target database and, accordingly, such writes can be ingested by SI 302 through the ingestion flow 316. The ingestion flow 316 can be or can include an event stream, change data capture (CDC) system, replication system, or similar that can capture changes in the source database and replicate the changes in a write to SI.

### Touch Aware Authorization

As discussed above, applying access policy decisions based on touched paths of a query can be important in ensuring sensitive information is not leaked in a query. A touched path can describe data fields in a query that are dereferenced, evaluated, accessed indirectly, accessed through computation, and/or used in join or subquery predicates. By analyzing touched paths and applying access control policies to each touched field, rather than an output of a query, sensitive information can be better protected from inference attacks. Furthermore, touch-aware authorization can improve access control in hybrid data environments and in data systems with various disparate data stores by enabling evaluation of nested fields within semi-structured data and by providing an abstracted authorization layer outside implementations by any single data store.

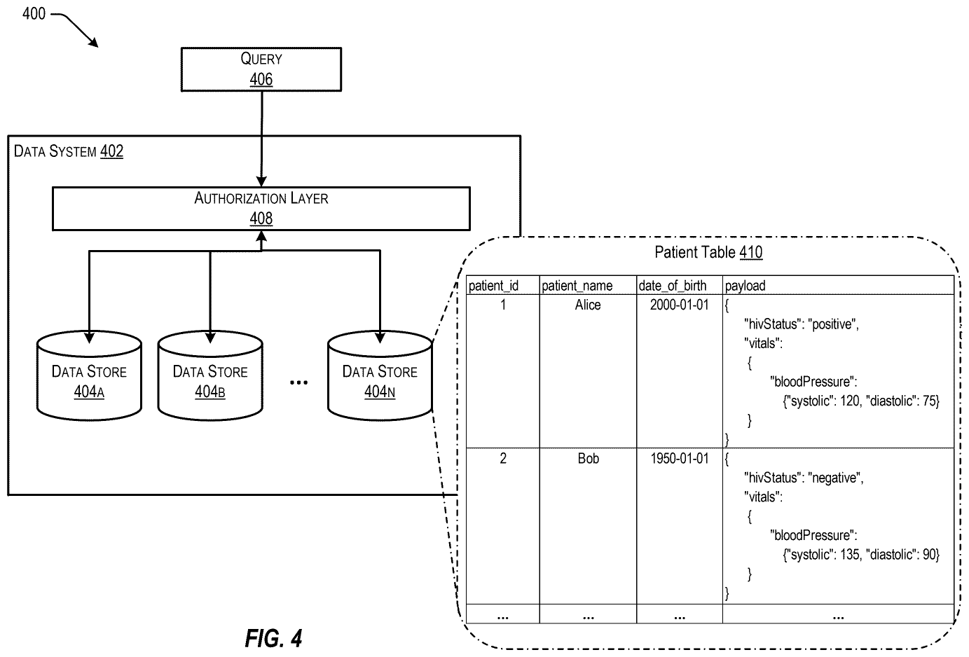

FIG. 4 is a block diagram illustrating an exemplary computing environment 400 implementing touch-aware authorization, in accordance with various embodiments. The computing environment 400 can include a data system 402 (e.g., SI 302 of FIG. 3). The data system 402 can include a plurality of data stores 604a-n. As a particular example, a data store in the data storage system can be a hybrid relational and semi-structured database including tables with columns that include document data.

The data system 402 can include an authorization layer 408 that analyzes queries to evaluate access policies based on touched paths of the query. The authorization layer 408 can function as a middleware layer that analyzes queries and performs authorization analysis of queries prior to execution on any particular data store 404a-n. The authorization layer 408 can act as an abstraction layer for systems with pluralities of data stores by parsing and evaluating touched paths of queries prior to processing performed by the particular data store. As such, queries directed towards multiple data stores in the system may be parsed and evaluated by the authorization layer 408 without separate and/or distinct evaluations for authorization for each data store.

The data system 402 can receive a query 406 via a transactional layer (e.g., an API endpoint, etc.). The query 406 may be a programming language query (e.g., SQL, QDSL, etc.) that can be executed on one or more data stores 404a-n. In some examples, the query 406 is generated by a component of a CDA system as described with respect to FIGS. 1-2 based on a natural language utterance received from an end user. For example, a healthcare provider may ask a digital assistant for information about the medical condition of a particular patient. In such examples, the authorization layer 408 may determine whether the healthcare provider (or other user and/or entity requesting information) has the access permissions to access the requested data.

The authorization layer 408 enforces access control policy by performing semantic introspection of the query 406 to extract touched paths within the query 406. Performing semantic introspection can include parsing the query and determining semantic attributes of the query including but not limited to the structure of the query, data types, table and column references, nested clauses, etc., to extract touched paths of the query 406. The touched paths include structured paths (e.g., columns and rows with atomic values) and/or nested paths within semi-structured (e.g., JSON, XML) fields. The set of touched paths extracted for the query 406 can be referred to as a data path of the query 406.

A data store 404n may be a database supporting a hybrid relational-document model. An example hybrid table 410 is depicted in FIG. 4 that includes structured columns for patient_id and patient_name (e.g., columns with atomic values) and a payload column including semi-structured data (e.g., JSON). When receiving the query for data in example hybrid table 410, touched paths across the structured columns and semi-structured columns is determined to evaluate access control. As an example, an access control policy implemented by the data system 402 may indicate that date_of_birth, and hivStatus are sensitive information. The data system 402 may receive the following query requesting patient information from patient table 410:
SELECT name FROM patient WHERE date_of_birth <‘1960-01-01’;

For the above example, the authorization layer 408 performs semantic introspection and determines the touched paths of the query are patient.name and patient.age because values from both columns are used to evaluate the query. However, because ‘date_of_birth’ is a restricted value, the query 406 violates an access policy of the system and the authorization layer 408 may perform an enforcement action to prevent the query from executing (e.g., blocking the query, masking the query, etc.). As an example, the above example query may be generated based on the natural language utterance “What are the names of all patients who were born before 1960?” provided by a healthcare professional to digital assistant as described with respect to FIGS. 1-2.

The access policy evaluation can be used to determine whether the healthcare professional has access privileges to request such data.

As another example, the data system 402 may receive the following query requesting the HIV status of a patient from patient table 410:
SELECT json_value(payload, ‘$.hivStatus’) AS status FROM patient;

The authorization layer 408 determines the touched paths of the query to be payload.hivStatus.

In some instances, the query can include a call to a UDF. For example, a query received by the data system 402 can be:
SELECT assess_risk(payload) AS risk_level FROM patient;
   where assess_risk( ) is a UDF. The assess_risk( ) function may be as follows:

FUNCTION assess_risk(payload JSON) RETURNS TEXT
IMMUTABLE AS ( CASE WHEN json_value(payload, ‘$.hivStatus') =
‘positive’ THEN ‘HIGH’ ELSE ‘Low’ END )

In such instances, performing access control without evaluating the UDF can be harmful as a touched path of the function is payload.hivStatus, which is restricted according to the access policies of the system. Accordingly, the authorization layer 408 may perform analysis of the UDF by identifying touched paths based on introspection of the input fields of the UDF and/or by checking pre-registered metadata (e.g., known touched paths, etc.) associated with the UDF to determine whether the UDF is safe to execute.

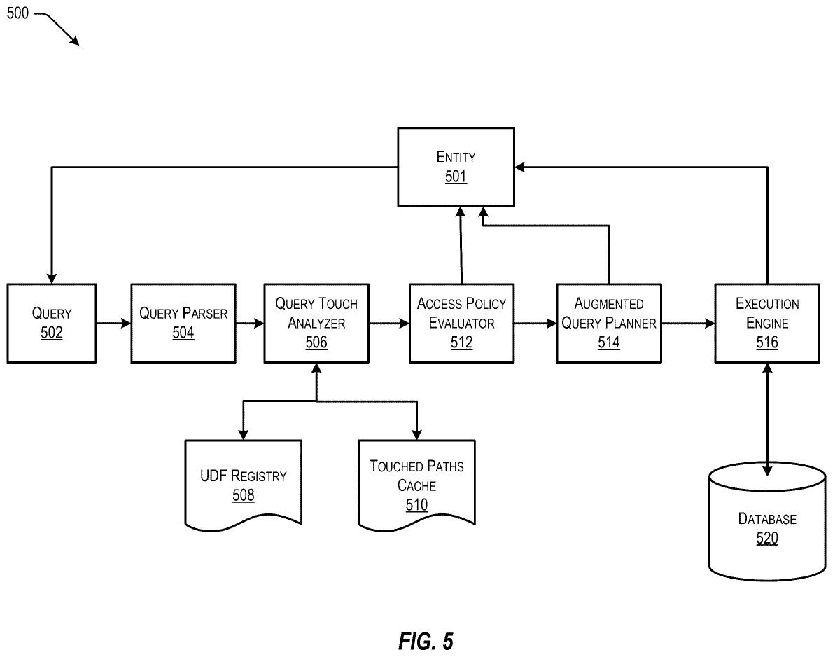

FIG. 5 is a block diagram illustrating an exemplary flow 500 for enforcing access control with touched paths in a hybrid data system, in accordance with various embodiments.

Processing described in FIG. 5 relates to processing SQL queries to relational databases with hybrid relational and document data. This is not intended to be limiting, however, and similar processing can be applied to various other types of queries (e.g., Vector DSL queries, etc.) to various other types of data stores (e.g., relational databases without hybrid data, vector databases, etc.). The flow 500 can be integrated with additional query engines (e.g., SQL query engines) to augment query planning and execution control layers and can be performed at compile time of a query (e.g., prior to execution of the query).

A query 502 can be received at a data system (e.g., SI as described with respect to FIGS. 1-3) from an entity 501 (e.g., an end user, component of a CDA system, etc.). In this flow 500, the query 502 can be directed towards data in a hybrid database containing relational tables with semi-structured fields (e.g., data in patient table 410 of FIG. 4). A query parser 504 (e.g., Apache Calcite, ANTLR-based parsers, etc.) converts the query string into a query representation. Examples of query representations include, but are not limited to, parse trees, concrete syntax trees, intermediate representations, abstract syntax trees (AST), etc. As a particular example, the query parser 504 generates an AST, which represents the query as a hierarchical structure including nodes for each construct within the query 502. The AST can be generated by performing a lexical analysis (e.g., tokenization) of the query 502 string to determine tokens (e.g., keywords, identifiers, operators, etc.) of the query 502. The query parser 504 can perform syntactic analysis (e.g., by applying SQL grammar rules) to the tokens to generate an AST including nodes representing a syntactic and/or semantic construct of the query 502. Nodes of the AST represent a hierarchy of constructs in the query 502. For example, a root node of the AST can represent the top-level construct in a SQL query (e.g., a SELECT statement), an inner node can represent clauses or expressions in the SQL query (e.g., WHERE clause, JOIN clause, etc.), and leaf nodes can represent atomic elements in the SQL query (e.g., column names, constants, etc.).

The query parser 504 sends the query representation (e.g., AST) to a query touch analyzer 506 to perform semantic introspection of the query representation to extract the touched paths within the query. Continuing with the example query representation as an AST, the query touch analyzer 506 performs a traversal of the AST generated by the query parser 504 to determine the touched paths of the query. For each node in the AST, the query touch analyzer 506 determines the touched paths of the node based on the type of construct represented by the node. The query touch analyzer 506 can generate a data path (e.g., a set of touched paths) and add each touched path identified per node to the set of touched paths. If a node is a column reference (e.g., patient_name in patient table 410 of FIG. 4), the query touch analyzer 506 adds a fully qualified name for the column reference to the set of touched paths. If the node is a nested path expression (e.g., a JSONPathExpression), the touched path is extracted by performing document path parsing. For such nested path expressions (e.g., in the above json_value (payload, ‘$.hivStatus’) example), the touched path expression can be canonicalized into dot-notation paths (e.g., payload.hivStatus). Additionally or alternatively, document path parsing may support SQL and/or JSON accessors, JSONPath expressions in computed clauses, and path indexing.

If the node is a function call, the query touch analyzer 506 can be recursively extract fields from the arguments of the function call. Additionally or alternatively, if the node is a computed expression, the query touch analyzer 560 can recursively extract base fields. Base fields can refer to fields within the query 502 that are used as inputs of the computed expression.

If the node is a join or a subquery, touched paths can be recursively extracted and merged for each join condition and/or subquery.

If the node is a UDF call, the query touch analyzer 506 determines whether the UDF is registered in a UDF registry 508. The UDF registry 508 can be a table, database, repository, or similar If the UDF is registered, precomputed field metadata may be used for the UDF. UDFs in the UDF registry 508 can be registered using known information about the UDF. For example, a UDF may be registered by an administrator of the data system. Additionally or alternatively, a UDF may be dynamically registered using derived information about the UDF during touched path evaluation of a query containing the UDF. UDF metadata included in the UDF registry 508 about each UDF can include, but is not limited to, input field names, touched paths, and safety metadata. The safety metadata can include parameters indicating properties of the UDF (e.g., immutability) and whether the query touch analyzer 506 can predictably and/or safely rely on the UDF when performing a touched paths analysis. In some instances, the touched paths of the UDF can be different than touched paths determined from semantic introspection. If a UDF and/or metadata for the UDF is not included in the UDF registry 508, the query touch analyzer 506 can conservatively assume all referenced input fields are touched.

In some examples, the query touch analyzer 506 accesses a touched paths cache 510 that includes touched paths determined for previous queries. When performing the touched paths analysis to determine a data path (e.g., set of touched paths) for a query, the query touch analyzer 506 may cache the determined data path in the touched paths cache 510. In instances where the query touch analyzer 506 receives a parsed query for which touched paths were previously determined, the query touch analyzer 506 can retrieve the previously determined data path for the query from the touched paths cache 510 to improve efficiency of processing and evaluation for each received query.

The query touch analyzer 506 sends the identified data path including the set of identified touched paths to an access policy evaluator 512. The access policy evaluator 512 can determine an enforcement mode based on one or more access policies. The access policies may be defined by a user and/or entity managing the data system. The access policies can define whether the identified touched path is restricted or not (e.g., whether the touched path can safely be used to generate query results). If the access policy evaluator 512 determines all touched paths are allowed, the query 502 may be approved for execution on the intended database.

Alternatively, if one or more touched paths are unauthorized, the access policy evaluator 512 can apply one or more enforcement modes to the query. Enforcement modes can include but are not limited to block, rewrite, and mask.

To apply a block enforcement mode, the access policy evaluator 512 can reject the query at compile time. In such enforcement modes, the query 502 may not be provided to an execution engine 516 to execute the query 502. Instead, an indication can be provided to the entity 501 that query 502 cannot be executed. For example, the entity 501 may be provided with an error message indicating the query 502 violates one or more access policies.

To apply a rewrite enforcement mode, the access policy evaluator 512 can remove and/or replace unauthorized expressions within the query 502. For example, if query is a select statement that selects multiple fields but only one field of the referenced fields is unauthorized, the unauthorized field may be removed from the query 502 to provide results for the remaining fields in the query. To apply a mask enforcement mode, the query result can be modified to mask the restricted values. For example, a query result including a column with sensitive data may be replaced with NULL values and/or uniform masked values.

The access policy evaluator 512 can provide parsed queries that do not violate any access policies to a query optimizer (e.g., augmented query planner 514) to generate an execution plan that can be executed by the execution engine 516 to retrieve the requested data from a database 520. The results are then provided to the entity 501. For queries that violate one or more access policies in a rewrite enforcement mode, the queries may be provided and executed as rewritten queries without the unauthorized fields. Additionally or alternatively, an execution plan can be generated that indicates the results retrieved from the database 520 should be modified to remove sensitive information from the query result provided to the entity 501.

In some instances, the entity 501 can request information about touched fields in an execution plan through an augmented explain command in the query 502. For example, the entity 501 may execute a SQL EXPLAIN query to understand touched path metadata per plan node of an execution plan. The query touch analyzer 506 can provide the determined data path of the set of touched paths to the augmented query planner 514. The augmented query planner 514 can annotate touched fields per logical operator and surface the touched fields through a response to the entity 501. The execution plan includes the steps the execution engine 516 would take to execute the query. Each plan node can correspond to an individual operation in the execution plan. In some examples, the execution plan may be generated by a separate query optimizer (not depicted) and the augmented query planner 514 may annotate the execution plan with the touched paths for the plan nodes determined by the query optimizer.

An example SQL EXPLAIN extended with an option to show touched paths for each plan node can be as follows:

EXPLAIN WITH ACCESSED FIELDS SELECT name FROM patient
WHERE json_value(payload, ‘$.hivStatus') = ‘positive’;

An example execution plan annotated with touched paths metadata provided to the entity 501 can be as follows:

| Plan Node | Accessed Fields |
|---|---|
| Seq Scan | payload.hivStatus, name |
| Filter | payload.hivStatus |
| Output | name |

### Illustrative Methods

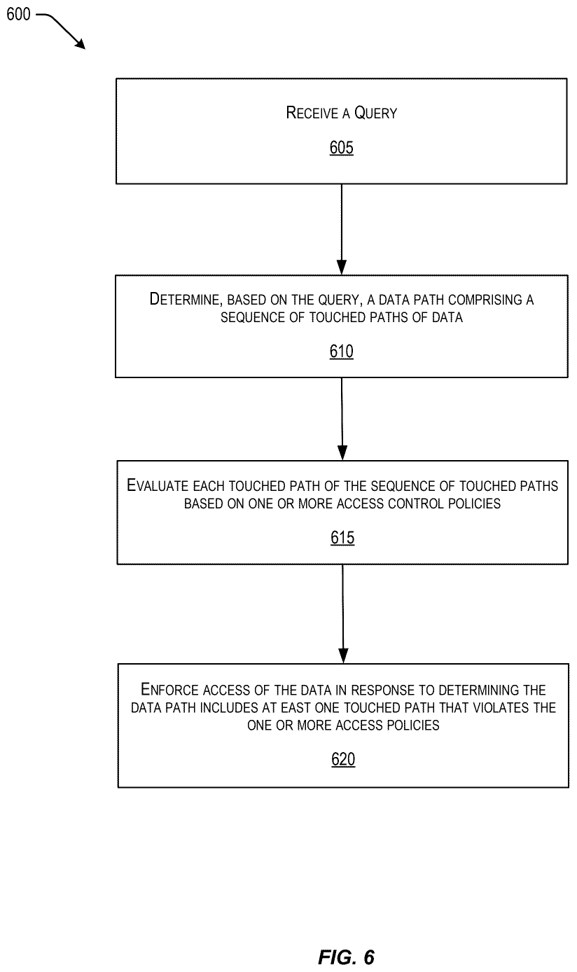

FIG. 6 is a flowchart of a process 600 for replicating a data transaction from a source data store to a target data store in accordance with various embodiments. The processing depicted in FIG. 6 may be implemented in software (e.g., code, instructions, program) executed by one or more processing units (e.g., processors, cores) of the respective systems, hardware, or combinations thereof. The software may be stored on a non-transitory storage medium (e.g., on a memory device). The process presented in FIG. 6 and described below is intended to be illustrative and non-limiting. Although FIG. 6 illustrates the various processing steps occurring in a particular sequence or order, this is not intended to be limiting. In certain alternative embodiments, the steps may be performed in some different order or some steps may also be performed at least partially in parallel. In certain embodiments, the processing depicted in FIG. 6 may be performed by one or more of the components, computing devices, services, or the like, such as a data storage system, semantic index, etc., illustrated and described with respect to FIGS. 1-5 and FIGS. 7-11.

At step 605, a query is received. The query can include request for data stored in a data system. In some examples, the query is generated by an entity based on a natural language provided by an end user (e.g., by a CDA system as described with respect to FIGS. 1-2).

At step 610, a data path is determined based on the query. The data path can include a set of touched paths of data in the data system. A touched path of the set of touched path may be used to access a different touched path of the set of touched paths. In some examples, the data in the system is hybrid data including relational data and document-based data.

In some examples, determining the data path include generating a hierarchical data structure (e.g., an abstract syntax tree (AST)) based on the query and the data in the data system (e.g., by query parser 504 of FIG. 5). At least part of the data may correspond to a nested structure (e.g., as shown in patient table 410 of FIG. 4). The set of touched paths can be identified by performing a traversal of the hierarchical data structure.

At step 615, each touched path of the set of touched paths is evaluated based on one or more access control policies (e.g., by access policy evaluator 512 of FIG. 5). Evaluating the touched paths can include determining whether at least one touched path of the set of touched paths violates the one or more access control policies.

In some examples, the query can include a user-defined function (UDF). UDF metadata associated with the UDF can be identified from a UDF registry (e.g., UDF registry 508 of FIG. 5). The UDF metadata can include input parameters associated with the UDF, one or more touched paths associated with the UDF and/or one or more data safety parameters. The process 600 can further include determining whether the UDF violates the one or more access control policies.

At step 620, access control of the data can be enforced in response to determining the data path includes at least one touched path that violates the one or more access policies. Access control may be enforced by controlling execution of the query on the data system based on the one or more access control policies. In some examples, enforcing access control can include rejecting the query, rewriting an unauthorized expression of the query, and/or masking a restricted field of the query.

In some examples, a predicted output of the query does not violate the one or more access control policies and the data path includes at least one touched path that violates the one or more access control policies. For example, a column in a SELECT clause may not violate access control policies, but a column used in a WHERE clause to filter the output may violate access control policies.

In some examples, a query result may be generated in response to determining the data path does not include at least one touched path that violates the one or more access control policies. In some examples, a query execution plan can generated based on the data path. The query execution plan can include metadata for touched path of the set of touched paths. The query execution plan may be executed if the data path is determined to no include at least one touched path that violates the one or more access policies.

### Examples of Architectures for Implementing Cloud Infrastructures

As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand)) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

FIG. 7 is a block diagram 700 illustrating an example pattern of an IaaS architecture, according to at least one embodiment. Service operators 702 can be communicatively coupled to a secure host tenancy 704 that can include a virtual cloud network (VCN) 706 and a secure host subnet 708. In some examples, the service operators 702 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 706 and/or the Internet.

The VCN 706 can include a local peering gateway (LPG) 710 that can be communicatively coupled to a secure shell (SSH) VCN 712 via an LPG 710 contained in the SSH VCN 712. The SSH VCN 712 can include an SSH subnet 714, and the SSH VCN 712 can be communicatively coupled to a control plane VCN 716 via the LPG 710 contained in the control plane VCN 716. Also, the SSH VCN 712 can be communicatively coupled to a data plane VCN 718 via an LPG 710. The control plane VCN 716 and the data plane VCN 718 can be contained in a service tenancy 719 that can be owned and/or operated by the IaaS provider.

The control plane VCN 716 can include a control plane demilitarized zone (DMZ) tier 720 that acts as a perimeter network (e.g., portions of a corporate network between the corporate intranet and external networks). The DMZ-based servers may have restricted responsibilities and help keep breaches contained. Additionally, the DMZ tier 720 can include one or more load balancer (LB) subnet(s) 722, a control plane app tier 724 that can include app subnet(s) 726, a control plane data tier 728 that can include database (DB) subnet(s) 730 (e.g., frontend DB subnet(s) and/or backend DB subnet(s)). The LB subnet(s) 722 contained in the control plane DMZ tier 720 can be communicatively coupled to the app subnet(s) 726 contained in the control plane app tier 724 and an Internet gateway 734 that can be contained in the control plane VCN 716, and the app subnet(s) 726 can be communicatively coupled to the DB subnet(s) 730 contained in the control plane data tier 728 and a service gateway 736 and a network address translation (NAT) gateway 738. The control plane VCN 716 can include the service gateway 736 and the NAT gateway 738.

The control plane VCN 716 can include a data plane mirror app tier 740 that can include app subnet(s) 726. The app subnet(s) 726 contained in the data plane mirror app tier 740 can include a virtual network interface controller (VNIC) 742 that can execute a compute instance 744. The compute instance 744 can communicatively couple the app subnet(s) 726 of the data plane mirror app tier 740 to app subnet(s) 726 that can be contained in a data plane app tier 746.

The data plane VCN 718 can include the data plane app tier 746, a data plane DMZ tier 748, and a data plane data tier 750. The data plane DMZ tier 748 can include LB subnet(s) 722 that can be communicatively coupled to the app subnet(s) 726 of the data plane app tier 746 and the Internet gateway 734 of the data plane VCN 718. The app subnet(s) 726 can be communicatively coupled to the service gateway 736 of the data plane VCN 718 and the NAT gateway 738 of the data plane VCN 718. The data plane data tier 750 can also include the DB subnet(s) 730 that can be communicatively coupled to the app subnet(s) 726 of the data plane app tier 746.

The Internet gateway 734 of the control plane VCN 716 and of the data plane VCN 718 can be communicatively coupled to a metadata management service 752 that can be communicatively coupled to public Internet 754. Public Internet 754 can be communicatively coupled to the NAT gateway 738 of the control plane VCN 716 and of the data plane VCN 718. The service gateway 736 of the control plane VCN 716 and of the data plane VCN 718 can be communicatively coupled to cloud services 756.

In some examples, the service gateway 736 of the control plane VCN 716 or of the data plane VCN 718 can make application programming interface (API) calls to cloud services 756 without going through public Internet 754. The API calls to cloud services 756 from the service gateway 736 can be one-way: the service gateway 736 can make API calls to cloud services 756, and cloud services 756 can send requested data to the service gateway 736. But, cloud services 756 may not initiate API calls to the service gateway 736.

In some examples, the secure host tenancy 704 can be directly connected to the service tenancy 719, which may be otherwise isolated. The secure host subnet 708 can communicate with the SSH subnet 714 through an LPG 710 that may enable two-way communication over an otherwise isolated system. Connecting the secure host subnet 708 to the SSH subnet 714 may give the secure host subnet 708 access to other entities within the service tenancy 719.

The control plane VCN 716 may allow users of the service tenancy 719 to set up or otherwise provision desired resources. Desired resources provisioned in the control plane VCN 716 may be deployed or otherwise used in the data plane VCN 718. In some examples, the control plane VCN 716 can be isolated from the data plane VCN 718, and the data plane mirror app tier 740 of the control plane VCN 716 can communicate with the data plane app tier 746 of the data plane VCN 718 via VNICs 742 that can be contained in the data plane mirror app tier 740 and the data plane app tier 746.

In some examples, users of the system, or customers, can make requests, for example create, read, update, or delete (CRUD) operations, through public Internet 754 that can communicate the requests to the metadata management service 752. The metadata management service 752 can communicate the request to the control plane VCN 716 through the Internet gateway 734. The request can be received by the LB subnet(s) 722 contained in the control plane DMZ tier 720. The LB subnet(s) 722 may determine that the request is valid, and in response to this determination, the LB subnet(s) 722 can transmit the request to app subnet(s) 726 contained in the control plane app tier 724. If the request is validated and requires a call to public Internet 754, the call to public Internet 754 may be transmitted to the NAT gateway 738 that can make the call to public Internet 754. Metadata that may be desired to be stored by the request can be stored in the DB subnet(s) 730.

In some examples, the data plane mirror app tier 740 can facilitate direct communication between the control plane VCN 716 and the data plane VCN 718. For example, changes, updates, or other suitable modifications to configuration may be desired to be applied to the resources contained in the data plane VCN 718. Via a VNIC 742, the control plane VCN 716 can directly communicate with, and can thereby execute the changes, updates, or other suitable modifications to configuration to, resources contained in the data plane VCN 718.

In some embodiments, the control plane VCN 716 and the data plane VCN 718 can be contained in the service tenancy 719. In this case, the user, or the customer, of the system may not own or operate either the control plane VCN 716 or the data plane VCN 718. Instead, the IaaS provider may own or operate the control plane VCN 716 and the data plane VCN 718, both of which may be contained in the service tenancy 719. This embodiment can enable isolation of networks that may prevent users or customers from interacting with other users', or other customers', resources. Also, this embodiment may allow users or customers of the system to store databases privately without needing to rely on public Internet 754, which may not have a desired level of threat prevention, for storage.

In other embodiments, the LB subnet(s) 722 contained in the control plane VCN 716 can be configured to receive a signal from the service gateway 736. In this embodiment, the control plane VCN 716 and the data plane VCN 718 may be configured to be called by a customer of the IaaS provider without calling public Internet 754. Customers of the IaaS provider may desire this embodiment since database(s) that the customers use may be controlled by the IaaS provider and may be stored on the service tenancy 719, which may be isolated from public Internet 754.

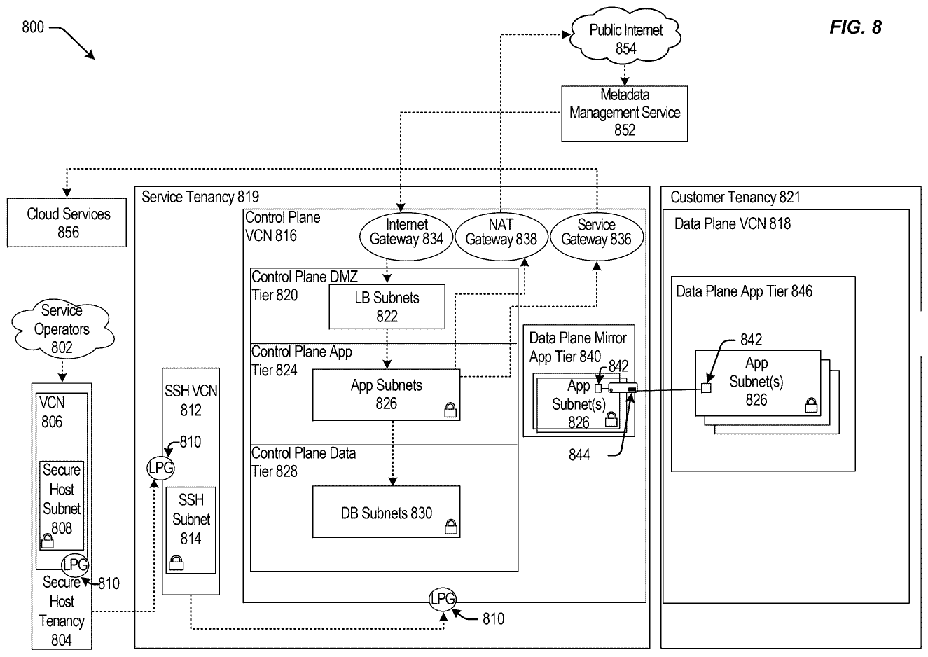

FIG. 8 is a block diagram 800 illustrating another example pattern of an IaaS architecture, according to at least one embodiment. Service operators 802 (e.g., service operators 702 of FIG. 7) can be communicatively coupled to a secure host tenancy 804 (e.g., the secure host tenancy 704 of FIG. 7) that can include a virtual cloud network (VCN) 806 (e.g., the VCN 706 of FIG. 7) and a secure host subnet 808 (e.g., the secure host subnet 708 of FIG. 7). The VCN 806 can include a local peering gateway (LPG) 810 (e.g., the LPG 710 of FIG. 7) that can be communicatively coupled to a secure shell (SSH) VCN 812 (e.g., the SSH VCN 712 of FIG. 7) via an LPG 710 contained in the SSH VCN 812. The SSH VCN 812 can include an SSH subnet 814 (e.g., the SSH subnet 714 of FIG. 7), and the SSH VCN 812 can be communicatively coupled to a control plane VCN 816 (e.g., the control plane VCN 716 of FIG. 7) via an LPG 810 contained in the control plane VCN 816. The control plane VCN 816 can be contained in a service tenancy 819 (e.g., the service tenancy 719 of FIG. 7), and the data plane VCN 818 (e.g., the data plane VCN 718 of FIG. 7) can be contained in a customer tenancy 821 that may be owned or operated by users, or customers, of the system.

The control plane VCN 816 can include a control plane DMZ tier 820 (e.g., the control plane DMZ tier 720 of FIG. 7) that can include LB subnet(s) 822 (e.g., LB subnet(s) 722 of FIG. 7), a control plane app tier 824 (e.g., the control plane app tier 724 of FIG. 7) that can include app subnet(s) 826 (e.g., app subnet(s) 726 of FIG. 7), a control plane data tier 828 (e.g., the control plane data tier 728 of FIG. 7) that can include database (DB) subnet(s) 830 (e.g., similar to DB subnet(s) 730 of FIG. 7). The LB subnet(s) 822 contained in the control plane DMZ tier 820 can be communicatively coupled to the app subnet(s) 826 contained in the control plane app tier 824 and an Internet gateway 834 (e.g., the Internet gateway 734 of FIG. 7) that can be contained in the control plane VCN 816, and the app subnet(s) 826 can be communicatively coupled to the DB subnet(s) 830 contained in the control plane data tier 828 and a service gateway 836 (e.g., the service gateway 736 of FIG. 7) and a network address translation (NAT) gateway 838 (e.g., the NAT gateway 738 of FIG. 7). The control plane VCN 816 can include the service gateway 836 and the NAT gateway 838.

The control plane VCN 816 can include a data plane mirror app tier 840 (e.g., the data plane mirror app tier 740 of FIG. 7) that can include app subnet(s) 826. The app subnet(s) 826 contained in the data plane mirror app tier 840 can include a virtual network interface controller (VNIC) 842 (e.g., the VNIC of 742) that can execute a compute instance 844 (e.g., similar to the compute instance 744 of FIG. 7). The compute instance 844 can facilitate communication between the app subnet(s) 826 of the data plane mirror app tier 840 and the app subnet(s) 826 that can be contained in a data plane app tier 846 (e.g., the data plane app tier 746 of FIG. 7) via the VNIC 842 contained in the data plane mirror app tier 840 and the VNIC 842 contained in the data plane app tier 846.

The Internet gateway 834 contained in the control plane VCN 816 can be communicatively coupled to a metadata management service 852 (e.g., the metadata management service 752 of FIG. 7) that can be communicatively coupled to public Internet 854 (e.g., public Internet 754 of FIG. 7). Public Internet 854 can be communicatively coupled to the NAT gateway 838 contained in the control plane VCN 816. The service gateway 836 contained in the control plane VCN 816 can be communicatively coupled to cloud services 856 (e.g., cloud services 756 of FIG. 7).

In some examples, the data plane VCN 818 can be contained in the customer tenancy 821. In this case, the IaaS provider may provide the control plane VCN 816 for each customer, and the IaaS provider may, for each customer, set up a unique compute instance 844 that is contained in the service tenancy 819. Each compute instance 844 may allow communication between the control plane VCN 816, contained in the service tenancy 819, and the data plane VCN 818 that is contained in the customer tenancy 821. The compute instance 844 may allow resources, that are provisioned in the control plane VCN 816 that is contained in the service tenancy 819, to be deployed or otherwise used in the data plane VCN 818 that is contained in the customer tenancy 821.

In other examples, the customer of the IaaS provider may have databases that live in the customer tenancy 821. In this example, the control plane VCN 816 can include the data plane mirror app tier 840 that can include app subnet(s) 826. The data plane mirror app tier 840 can reside in the data plane VCN 818, but the data plane mirror app tier 840 may not live in the data plane VCN 818. That is, the data plane mirror app tier 840 may have access to the customer tenancy 821, but the data plane mirror app tier 840 may not exist in the data plane VCN 818 or be owned or operated by the customer of the IaaS provider. The data plane mirror app tier 840 may be configured to make calls to the data plane VCN 818 but may not be configured to make calls to any entity contained in the control plane VCN 816. The customer may desire to deploy or otherwise use resources in the data plane VCN 818 that are provisioned in the control plane VCN 816, and the data plane mirror app tier 840 can facilitate the desired deployment, or other usage of resources, of the customer.

In some embodiments, the customer of the IaaS provider can apply filters to the data plane VCN 818. In this embodiment, the customer can determine what the data plane VCN 818 can access, and the customer may restrict access to public Internet 854 from the data plane VCN 818. The IaaS provider may not be able to apply filters or otherwise control access of the data plane VCN 818 to any outside networks or databases. Applying filters and controls by the customer onto the data plane VCN 818, contained in the customer tenancy 821, can help isolate the data plane VCN 818 from other customers and from public Internet 854.

In some embodiments, cloud services 856 can be called by the service gateway 836 to access services that may not exist on public Internet 854, on the control plane VCN 816, or on the data plane VCN 818. The connection between cloud services 856 and the control plane VCN 816 or the data plane VCN 818 may not be live or continuous. Cloud services 856 may exist on a different network owned or operated by the IaaS provider. Cloud services 856 may be configured to receive calls from the service gateway 836 and may be configured to not receive calls from public Internet 854. Some cloud services 856 may be isolated from other cloud services 856, and the control plane VCN 816 may be isolated from cloud services 856 that may not be in the same region as the control plane VCN 816. For example, the control plane VCN 816 may be located in “Region 1,” and cloud service “Deployment 7,” may be located in Region 1 and in “Region 2.” If a call to Deployment 7 is made by the service gateway 836 contained in the control plane VCN 816 located in Region 1, the call may be transmitted to Deployment 7 in Region 1. In this example, the control plane VCN 816, or Deployment 7 in Region 1, may not be communicatively coupled to, or otherwise in communication with, Deployment 7 in Region 2.

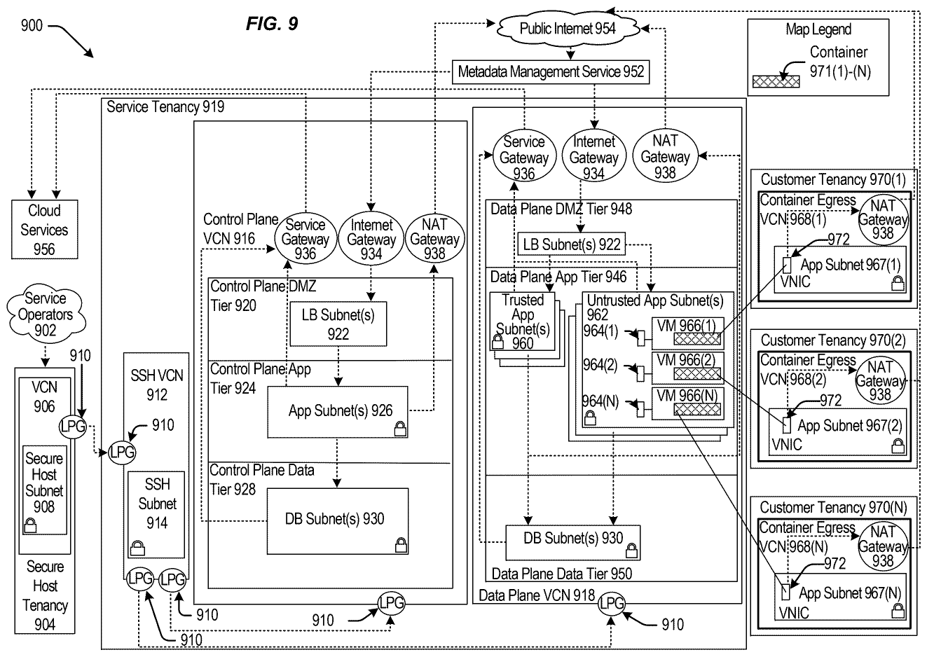

FIG. 9 is a block diagram 900 illustrating another example pattern of an IaaS architecture, according to at least one embodiment. Service operators 902 (e.g., service operators 702 of FIG. 7) can be communicatively coupled to a secure host tenancy 904 (e.g., the secure host tenancy 704 of FIG. 7) that can include a virtual cloud network (VCN) 906 (e.g., the VCN 706 of FIG. 7) and a secure host subnet 908 (e.g., the secure host subnet 708 of FIG. 7). The VCN 906 can include an LPG 910 (e.g., the LPG 710 of FIG. 7) that can be communicatively coupled to an SSH VCN 912 (e.g., the SSH VCN 712 of FIG. 7) via an LPG 910 contained in the SSH VCN 912. The SSH VCN 912 can include an SSH subnet 914 (e.g., the SSH subnet 714 of FIG. 7), and the SSH VCN 912 can be communicatively coupled to a control plane VCN 916 (e.g., the control plane VCN 716 of FIG. 7) via an LPG 910 contained in the control plane VCN 916 and to a data plane VCN 918 (e.g., the data plane 718 of FIG. 7) via an LPG 910 contained in the data plane VCN 918. The control plane VCN 916 and the data plane VCN 918 can be contained in a service tenancy 919 (e.g., the service tenancy 719 of FIG. 7).

The control plane VCN 916 can include a control plane DMZ tier 920 (e.g., the control plane DMZ tier 720 of FIG. 7) that can include load balancer (LB) subnet(s) 922 (e.g., LB subnet(s) 722 of FIG. 7), a control plane app tier 924 (e.g., the control plane app tier 724 of FIG. 7) that can include app subnet(s) 926 (e.g., similar to app subnet(s) 726 of FIG. 7), a control plane data tier 928 (e.g., the control plane data tier 728 of FIG. 7) that can include DB subnet(s) 930. The LB subnet(s) 922 contained in the control plane DMZ tier 920 can be communicatively coupled to the app subnet(s) 926 contained in the control plane app tier 924 and to an Internet gateway 934 (e.g., the Internet gateway 734 of FIG. 7) that can be contained in the control plane VCN 916, and the app subnet(s) 926 can be communicatively coupled to the DB subnet(s) 930 contained in the control plane data tier 928 and to a service gateway 936 (e.g., the service gateway of FIG. 7) and a network address translation (NAT) gateway 938 (e.g., the NAT gateway 738 of FIG. 7). The control plane VCN 916 can include the service gateway 936 and the NAT gateway 938.

The data plane VCN 918 can include a data plane app tier 946 (e.g., the data plane app tier 746 of FIG. 7), a data plane DMZ tier 948 (e.g., the data plane DMZ tier 748 of FIG. 7), and a data plane data tier 950 (e.g., the data plane data tier 750 of FIG. 7). The data plane DMZ tier 948 can include LB subnet(s) 922 that can be communicatively coupled to trusted app subnet(s) 960 and untrusted app subnet(s) 962 of the data plane app tier 946 and the Internet gateway 934 contained in the data plane VCN 918. The trusted app subnet(s) 960 can be communicatively coupled to the service gateway 936 contained in the data plane VCN 918, the NAT gateway 938 contained in the data plane VCN 918, and DB subnet(s) 930 contained in the data plane data tier 950. The untrusted app subnet(s) 962 can be communicatively coupled to the service gateway 936 contained in the data plane VCN 918 and DB subnet(s) 930 contained in the data plane data tier 950. The data plane data tier 950 can include DB subnet(s) 930 that can be communicatively coupled to the service gateway 936 contained in the data plane VCN 918.

The untrusted app subnet(s) 962 can include one or more primary VNICs 964(1)-(N) that can be communicatively coupled to tenant virtual machines (VMs) 966(1)-(N). Each tenant VM 966(1)-(N) can be communicatively coupled to a respective app subnet 967(1)-(N) that can be contained in respective container egress VCNs 968(1)-(N) that can be contained in respective customer tenancies 970(1)-(N). Respective secondary VNICs 972(1)-(N) can facilitate communication between the untrusted app subnet(s) 962 contained in the data plane VCN 918 and the app subnet contained in the container egress VCNs 968(1)-(N). Each container egress VCNs 968(1)-(N) can include a NAT gateway 938 that can be communicatively coupled to public Internet 954 (e.g., public Internet 754 of FIG. 7).

The Internet gateway 934 contained in the control plane VCN 916 and contained in the data plane VCN 918 can be communicatively coupled to a metadata management service 952 (e.g., the metadata management system 752 of FIG. 7) that can be communicatively coupled to public Internet 954. Public Internet 954 can be communicatively coupled to the NAT gateway 938 contained in the control plane VCN 916 and contained in the data plane VCN 918. The service gateway 936 contained in the control plane VCN 916 and contained in the data plane VCN 918 can be communicatively coupled to cloud services 956.

In some embodiments, the data plane VCN 918 can be integrated with customer tenancies 970. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 946. Code to run the function may be executed in the VMs 966(1)-(N), and the code may not be configured to run anywhere else on the data plane VCN 918. Each VM 966(1)-(N) may be connected to one customer tenancy 970. Respective containers 971(1)-(N) contained in the VMs 966(1)-(N) may be configured to run the code. In this case, there can be a dual isolation (e.g., the containers 971(1)-(N) running code, where the containers 971(1)-(N) may be contained in at least the VM 966(1)-(N) that are contained in the untrusted app subnet(s) 962), which may help prevent incorrect or otherwise undesirable code from damaging the network of the IaaS provider or from damaging a network of a different customer. The containers 971(1)-(N) may be communicatively coupled to the customer tenancy 970 and may be configured to transmit or receive data from the customer tenancy 970. The containers 971(1)-(N) may not be configured to transmit or receive data from any other entity in the data plane VCN 918. Upon completion of running the code, the IaaS provider may kill or otherwise dispose of the containers 971(1)-(N).

In some embodiments, the trusted app subnet(s) 960 may run code that may be owned or operated by the IaaS provider. In this embodiment, the trusted app subnet(s) 960 may be communicatively coupled to the DB subnet(s) 930 and be configured to execute CRUD operations in the DB subnet(s) 930. The untrusted app subnet(s) 962 may be communicatively coupled to the DB subnet(s) 930, but in this embodiment, the untrusted app subnet(s) may be configured to execute read operations in the DB subnet(s) 930. The containers 971(1)-(N) that can be contained in the VM 966(1)-(N) of each customer and that may run code from the customer may not be communicatively coupled with the DB subnet(s) 930.

In other embodiments, the control plane VCN 916 and the data plane VCN 918 may not be directly communicatively coupled. In this embodiment, there may be no direct communication between the control plane VCN 916 and the data plane VCN 918. However, communication can occur indirectly through at least one method. An LPG 910 may be established by the IaaS provider that can facilitate communication between the control plane VCN 916 and the data plane VCN 918. In another example, the control plane VCN 916 or the data plane VCN 918 can make a call to cloud services 956 via the service gateway 936. For example, a call to cloud services 956 from the control plane VCN 916 can include a request for a service that can communicate with the data plane VCN 918.

FIG. 10 is a block diagram 1000 illustrating another example pattern of an IaaS architecture, according to at least one embodiment. Service operators 1002 (e.g., service operators 702 of FIG. 7) can be communicatively coupled to a secure host tenancy 1004 (e.g., the secure host tenancy 704 of FIG. 7) that can include a virtual cloud network (VCN) 1006 (e.g., the VCN 706 of FIG. 7) and a secure host subnet 1008 (e.g., the secure host subnet 708 of FIG. 7). The VCN 1006 can include an LPG 1010 (e.g., the LPG 710 of FIG. 7) that can be communicatively coupled to an SSH VCN 1012 (e.g., the SSH VCN 712 of FIG. 7) via an LPG 1010 contained in the SSH VCN 1012. The SSH VCN 1012 can include an SSH subnet 1014 (e.g., the SSH subnet 714 of FIG. 7), and the SSH VCN 1012 can be communicatively coupled to a control plane VCN 1016 (e.g., the control plane VCN 716 of FIG. 7) via an LPG 1010 contained in the control plane VCN 1016 and to a data plane VCN 1018 (e.g., the data plane 718 of FIG. 7) via an LPG 1010 contained in the data plane VCN 1018. The control plane VCN 1016 and the data plane VCN 1018 can be contained in a service tenancy 1019 (e.g., the service tenancy 719 of FIG. 7).

The control plane VCN 1016 can include a control plane DMZ tier 1020 (e.g., the control plane DMZ tier 720 of FIG. 7) that can include LB subnet(s) 1022 (e.g., LB subnet(s) 722 of FIG. 7), a control plane app tier 1024 (e.g., the control plane app tier 724 of FIG. 7) that can include app subnet(s) 1026 (e.g., app subnet(s) 726 of FIG. 7), a control plane data tier 1028 (e.g., the control plane data tier 728 of FIG. 7) that can include DB subnet(s) 1030 (e.g., DB subnet(s) 930 of FIG. 9). The LB subnet(s) 1022 contained in the control plane DMZ tier 1020 can be communicatively coupled to the app subnet(s) 1026 contained in the control plane app tier 1024 and to an Internet gateway 1034 (e.g., the Internet gateway 734 of FIG. 7) that can be contained in the control plane VCN 1016, and the app subnet(s) 1026 can be communicatively coupled to the DB subnet(s) 1030 contained in the control plane data tier 1028 and to a service gateway 1036 (e.g., the service gateway of FIG. 7) and a network address translation (NAT) gateway 1038 (e.g., the NAT gateway 738 of FIG. 7). The control plane VCN 1016 can include the service gateway 1036 and the NAT gateway 1038.

The data plane VCN 1018 can include a data plane app tier 1046 (e.g., the data plane app tier 746 of FIG. 7), a data plane DMZ tier 1048 (e.g., the data plane DMZ tier 748 of FIG. 7), and a data plane data tier 1050 (e.g., the data plane data tier 750 of FIG. 7). The data plane DMZ tier 1048 can include LB subnet(s) 1022 that can be communicatively coupled to trusted app subnet(s) 1060 (e.g., trusted app subnet(s) 960 of FIG. 9) and untrusted app subnet(s) 1062 (e.g., untrusted app subnet(s) 962 of FIG. 9) of the data plane app tier 1046 and the Internet gateway 1034 contained in the data plane VCN 1018. The trusted app subnet(s) 1060 can be communicatively coupled to the service gateway 1036 contained in the data plane VCN 1018, the NAT gateway 1038 contained in the data plane VCN 1018, and DB subnet(s) 1030 contained in the data plane data tier 1050. The untrusted app subnet(s) 1062 can be communicatively coupled to the service gateway 1036 contained in the data plane VCN 1018 and DB subnet(s) 1030 contained in the data plane data tier 1050. The data plane data tier 1050 can include DB subnet(s) 1030 that can be communicatively coupled to the service gateway 1036 contained in the data plane VCN 1018.

The untrusted app subnet(s) 1062 can include primary VNICs 1064(1)-(N) that can be communicatively coupled to tenant virtual machines (VMs) 1066(1)-(N) residing within the untrusted app subnet(s) 1062. Each tenant VM 1066(1)-(N) can run code in a respective container 1067(1)-(N), and be communicatively coupled to an app subnet 1026 that can be contained in a data plane app tier 1046 that can be contained in a container egress VCN 1068. Respective secondary VNICs 1072(1)-(N) can facilitate communication between the untrusted app subnet(s) 1062 contained in the data plane VCN 1018 and the app subnet contained in the container egress VCN 1068. The container egress VCN can include a NAT gateway 1038 that can be communicatively coupled to public Internet 1054 (e.g., public Internet 754 of FIG. 7).

The Internet gateway 1034 contained in the control plane VCN 1016 and contained in the data plane VCN 1018 can be communicatively coupled to a metadata management service 1052 (e.g., the metadata management system 752 of FIG. 7) that can be communicatively coupled to public Internet 1054. Public Internet 1054 can be communicatively coupled to the NAT gateway 1038 contained in the control plane VCN 1016 and contained in the data plane VCN 1018. The service gateway 1036 contained in the control plane VCN 1016 and contained in the data plane VCN 1018 can be communicatively coupled to cloud services 1056.

In some examples, the pattern illustrated by the architecture of block diagram 1000 of FIG. 10 may be considered an exception to the pattern illustrated by the architecture of block diagram 900 of FIG. 9 and may be desirable for a customer of the IaaS provider if the IaaS provider cannot directly communicate with the customer (e.g., a disconnected region). The respective containers 1067(1)-(N) that are contained in the VMs 1066(1)-(N) for each customer can be accessed in real-time by the customer. The containers 1067(1)-(N) may be configured to make calls to respective secondary VNICs 1072(1)-(N) contained in app subnet(s) 1026 of the data plane app tier 1046 that can be contained in the container egress VCN 1068. The secondary VNICs 1072(1)-(N) can transmit the calls to the NAT gateway 1038 that may transmit the calls to public Internet 1054. In this example, the containers 1067(1)-(N) that can be accessed in real-time by the customer can be isolated from the control plane VCN 1016 and can be isolated from other entities contained in the data plane VCN 1018. The containers 1067(1)-(N) may also be isolated from resources from other customers.

In other examples, the customer can use the containers 1067(1)-(N) to call cloud services 1056. In this example, the customer may run code in the containers 1067(1)-(N) that requests a service from cloud services 1056. The containers 1067(1)-(N) can transmit this request to the secondary VNICs 1072(1)-(N) that can transmit the request to the NAT gateway that can transmit the request to public Internet 1054. Public Internet 1054 can transmit the request to LB subnet(s) 1022 contained in the control plane VCN 1016 via the Internet gateway 1034. In response to determining the request is valid, the LB subnet(s) can transmit the request to app subnet(s) 1026 that can transmit the request to cloud services 1056 via the service gateway 1036.

It should be appreciated that IaaS architectures 700, 800, 900, 1000 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

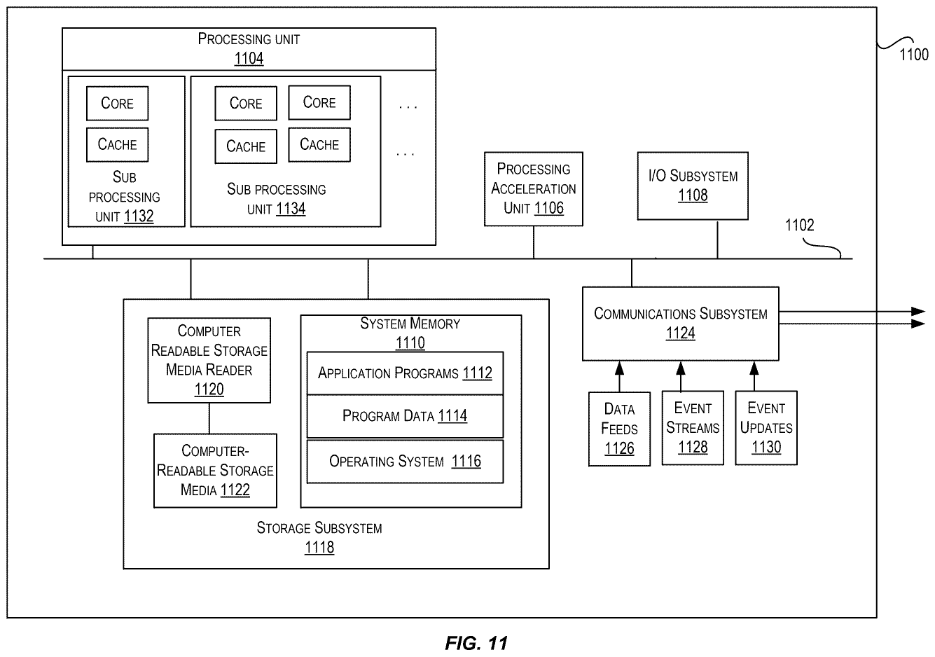

FIG. 11 illustrates an example computer system 1100, in which various embodiments may be implemented. The system 1100 may be used to implement any of the computer systems described above. As shown in the figure, computer system 1100 includes a processing unit 1104 that communicates with a number of peripheral subsystems via a bus subsystem 1102. These peripheral subsystems may include a processing acceleration unit 1106, an I/O subsystem 1108, a storage subsystem 1118 and a communications subsystem 1124. Storage subsystem 1118 includes tangible computer-readable storage media 1122 and a system memory 1110.

Bus subsystem 1102 provides a mechanism for letting the various components and subsystems of computer system 1100 communicate with each other as intended. Although bus subsystem 1102 is shown schematically as a single bus, alternative embodiments of the bus subsystem may utilize multiple buses. Bus subsystem 1102 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1104, which can be implemented as one or more integrated circuits (e.g., a conventional microprocessor or microcontroller), controls the operation of computer system 1100. One or more processors may be included in processing unit 1104. These processors may include single core or multicore processors. In certain embodiments, processing unit 1104 may be implemented as one or more independent processing units 1132 and/or 1134 with single or multicore processors included in each processing unit. In other embodiments, processing unit 1104 may also be implemented as a quad-core processing unit formed by integrating two dual-core processors into a single chip.

In various embodiments, processing unit 1104 can execute a variety of programs in response to program code and can maintain multiple concurrently executing programs or processes. At any given time, some or all of the program code to be executed can be resident in processor(s) 1104 and/or in storage subsystem 1118. Through suitable programming, processor(s) 1104 can provide various functionalities described above. Computer system 1100 may additionally include a processing acceleration unit 1106, which can include a digital signal processor (DSP), a special-purpose processor, and/or the like.

I/O subsystem 1108 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1100 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1100 may comprise a storage subsystem 1118 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 1104 provide the functionality described above. Storage subsystem 1118 may also provide a repository for storing data used in accordance with the present disclosure.

As depicted in the example in FIG. 11, storage subsystem 1118 can include various components including a system memory 1110, computer-readable storage media 1122, and a computer readable storage media reader 1120. System memory 1110 may store program instructions that are loadable and executable by processing unit 1104. System memory 1110 may also store data that is used during the execution of the instructions and/or data that is generated during the execution of the program instructions. Various different kinds of programs may be loaded into system memory 1110 including but not limited to client applications, Web browsers, mid-tier applications, relational database management systems (RDBMS), virtual machines, containers, etc.

System memory 1110 may also store an operating system 1116. Examples of operating system 1116 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 1100 executes one or more virtual machines, the virtual machines along with their guest operating systems (GOSs) may be loaded into system memory 1110 and executed by one or more processors or cores of processing unit 1104.

System memory 1110 can come in different configurations depending upon the type of computer system 1100. For example, system memory 1110 may be volatile memory (such as random access memory (RAM)) and/or non-volatile memory (such as read-only memory (ROM), flash memory, etc.) Different types of RAM configurations may be provided including a static random access memory (SRAM), a dynamic random access memory (DRAM), and others. In some implementations, system memory 1110 may include a basic input/output system (BIOS) containing basic routines that help to transfer information between elements within computer system 1100, such as during start-up.

Computer-readable storage media 1122 may represent remote, local, fixed, and/or removable storage devices plus storage media for temporarily and/or more permanently containing, storing, computer-readable information for use by computer system 1100 including instructions executable by processing unit 1104 of computer system 1100.

Computer-readable storage media 1122 can include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 1122 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1122 may include, but is not limited to, Zip® drives, flash memory cards, universal serial bus (USB) flash drives, secure digital (SD) cards, DVD disks, digital video tape, and the like. Computer-readable storage media 1122 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 1100.

Machine-readable instructions executable by one or more processors or cores of processing unit 1104 may be stored on a non-transitory computer-readable storage medium. A non-transitory computer-readable storage medium can include physically tangible memory or storage devices that include volatile memory storage devices and/or non-volatile storage devices.

Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 1124 provides an interface to other computer systems and networks. Communications subsystem 1124 serves as an interface for receiving data from and transmitting data to other systems from computer system 1100. For example, communications subsystem 1124 may enable computer system 1100 to connect to one or more devices via the Internet. In some embodiments communications subsystem 1124 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof)), global positioning system (GPS) receiver components, and/or other components. In some embodiments communications subsystem 1124 can provide wired network connectivity (e.g., Ethernet) in addition to or instead of a wireless interface.

In some embodiments, communications subsystem 1124 may also receive input communication in the form of structured and/or unstructured data feeds 1126, event streams 1128, event updates 1130, and the like on behalf of one or more users who may use computer system 1100.

By way of example, communications subsystem 1124 may be configured to receive data feeds 1126 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1124 may also be configured to receive data in the form of continuous data streams, which may include event streams 1128 of real-time events and/or event updates 1130, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1124 may also be configured to output the structured and/or unstructured data feeds 1126, event streams 1128, event updates 1130, and the like to one or more databases that may be in communication with one or more streaming data source computers coupled to computer system 1100.

Computer system 1100 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1100 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed.

Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or services are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A computer-implemented method, comprising:
receiving a query;
determining a data path based on the query, wherein the data path comprises a set of touched paths of domain data in a data system, wherein one or more touched paths of the set of touched paths is used to access a different touched path of the set of touched paths;
evaluating each touched path of the set of touched paths based on one or more access control policies, wherein the evaluating comprises determining whether at least one touched path of the set of touched paths violates the one or more access control policies; and
in response to determining the data path includes the at least one touched path that violates the one or more access control policies, enforcing access control of the domain data by controlling execution of the query on the data system based on the one or more access control policies.

2. The computer-implemented method of claim 1, further comprising:
in response to determining the data path does not include the at least one touched path that violates the one or more access control policies, generating a query result based on the domain data.

3. The computer-implemented method of claim 1, wherein:
a predicted output of the query does not violate the one or more access control policies; and
the data path includes the at least one touched path that violates the one or more access control policies.

4. The computer-implemented method of claim 1, wherein the data in the data system is hybrid data comprising relational data and document-based data.

5. The computer-implemented method of claim 1, wherein enforcing access control comprises at least one of (i) rejecting the query, (ii) rewriting an unauthorized expression of the query, (iii) masking a restricted field of the query, or (iv) a combination thereof.

6. The computer-implemented method of claim 1, wherein the query comprises a user-defined function (UDF), and wherein the computer-implemented method further comprises:
identifying, from a UDF registry, UDF metadata associated with the UDF, wherein the UDF metadata comprises at least one of (i) input parameters associated with the UDF, (ii) one or more touched paths associated with the UDF, and (iii) one or more data safety parameters; and
determining, based on the UDF metadata, whether the UDF violates the one or more access control policies.

7. The computer-implemented method of claim 1, further comprising:
generating a query execution plan based on the data path, wherein the query execution plan comprises metadata for each touched path of the set of touched paths; and
in response to determining the data path does not include the at least one touched path that violates the one or more access control policies, executing the query execution plan.

8. The computer-implemented method of claim 1, wherein determining the data path comprises:
generating a hierarchical data structure based on the query and the domain data in the data system, wherein at least part of the domain data corresponds to a nested structure; and
performing a traversal of the hierarchical data structure to identify the set of touched paths.

9. A system comprising:
one or more processors; and
one or more computer-readable media storing instructions which, when executed by the one or more processors, cause the system to perform operations comprising:
receiving a query;
determining a data path based on the query, wherein the data path comprises a set of touched paths of domain data in a data system, wherein each touched path of the set of touched paths is used to access a different touched path of the set of touched paths;
evaluating one or more touched paths of the set of touched paths based on one or more access control policies, wherein the evaluating comprises determining whether at least one touched path of the set of touched paths violates the one or more access control policies;
in response to determining the data path includes the at least one touched path that violates the one or more access control policies, enforcing access control of the domain data by controlling execution of the query on the data system based on the one or more access control policies; and
in response to determining the data path does not include the at least one touched path that violates the one or more access control policies, generating a query result based on the domain data.

10. The system of claim 9, wherein:
a predicted output of the query does not violate the one or more access control policies; and
the data path includes the at least one touched path that violates the one or more access control policies.

11. The system of claim 9, wherein the domain data in the data system is hybrid data comprising relational data and document-based data.

12. The system of claim 9, wherein enforcing access control comprises at least one of (i) rejecting the query, (ii) rewriting an unauthorized expression of the query, (iii) masking a restricted field of the query, or (iv) a combination thereof.

13. The system of claim 9, wherein the query comprises a user-defined function (UDF), and wherein the operations further comprise:
identifying, from a UDF registry, UDF metadata associated with the UDF, wherein the UDF metadata comprises at least one of (i) input parameters associated with the UDF, (ii) one or more touched paths associated with the UDF, and (iii) one or more data safety parameters; and
determining, based on the UDF metadata, whether the UDF violates the one or more access control policies.

14. The system of claim 9, wherein the operations further comprise:
generating a query execution plan based on the data path, wherein the query execution plan comprises metadata for each touched path of the set of touched paths; and
in response to determining the data path does not include the at least one touched path that violates the one or more access control policies, executing the query execution plan.

15. The system of claim 9, wherein determining the data path comprises:
generating a hierarchical data structure based on the query and the domain data in the data system, wherein at least part of the domain data corresponds to a nested structure; and
performing a traversal of the hierarchical data structure to identify the set of touched paths.

16. One or more non-transitory computer-readable media storing instructions which, when executed by one or more processors, cause the one or more processors to perform operations comprising:
receiving a query;
determining a data path based on the query, wherein the data path comprises a set of touched paths of data in a data system, wherein one or more touched paths of the set of touched paths is used to access a different touched path of the set of touched paths;
evaluating each touched path of the set of touched paths based on one or more access control policies, wherein the evaluating comprises determining whether at least one touched path of the set of touched paths violates the one or more access control policies;
in response to determining the data path includes the at least one touched path that violates the one or more access control policies, enforcing access control of the data by controlling execution of the query on the data system based on the one or more access control policies; and
in response to determining the data path does not include the at least one touched path that violates the one or more access control policies, generating a query result based on the data.

17. The one or more non-transitory computer-readable media of claim 16, wherein the data in the data system is hybrid data comprising relational data and document-based data.

18. The one or more non-transitory computer-readable media of claim 16, wherein enforcing access control comprises at least one of (i) rejecting the query, (ii) rewriting an unauthorized expression of the query, (iii) masking a restricted field of the query, or (iv) a combination thereof.

19. The one or more non-transitory computer-readable media of claim 16, wherein the query comprises a user-defined function (UDF), and wherein the operations further comprise:
identifying, from a UDF registry, UDF metadata associated with the UDF, wherein the UDF metadata comprises at least one of (i) input parameters associated with the UDF, (ii) one or more touched paths associated with the UDF, and (iii) one or more data safety parameters; and
determining, based on the UDF metadata, whether the UDF violates the one or more access control policies.

20. The one or more non-transitory computer-readable media of claim 16, wherein the operations further comprise:
generating a query execution plan based on the data path, wherein the query execution plan comprises metadata for each touched path of the set of touched paths; and
in response to determining the data path does not include the at least one touched path that violates the one or more access control policies, executing the query execution plan.
